(19) United States
(12) Patent Application Publication
(10) Pub. No.: US 2018/0102965 A1
(43) Pub. Date: Apr. 12, 2018

(54) UNICAST BRANCHING BASED MULTICAST

(71) Applicant: Alcatel-Lucent USA Inc., Murray Hill, NJ (US)

(72) Inventors: Adiseshu Hari, Holmdel, NJ (US); Tirunell V. Lakshman, Morganville, NJ (US); Gordon Wilfong, Florham Park, NJ (US)

(73) Assignee: Alcatel-Lucent USA Inc., Murray Hill, NJ (US)

(21) Appl. No.: 15/288,105

(22) Filed: Oct. 7, 2016

(51) Int. Cl. H04L 12/761; H04L 12/741; H04L 12/721

(52) U.S. Cl. CPC H04L 45/16; H04L 45/38; H04L 45/66; H04L 45/74

(57) ABSTRACT

The present disclosure generally discloses multicast communication support capabilities configured to support multicast communications of a multicast group using a multicast tree. The multicast communication support capabilities may include a unicast branching based multicast capability. The unicast branching based multicast capability may be configured to support determination and establishment of, as well as communication via, a multicast tree that is composed of unicast branches. The unicast branching based multicast capability may be configured to preserve the multicast information of multicast transmissions transported via the multicast tree even though the multicast transmissions are transported via unicast branches of the multicast tree. The unicast branching based multicast capability may be configured to preserve the multicast information of multicast transmissions transported via unicast branches of the multicast tree based on encoding of the multicast information within the packets of the multicast transmission being transported via the unicast branches of the multicast tree.

### TECHNICAL FIELD

The present disclosure relates generally to communication networks and, more particularly but not exclusively, to supporting multicasting in various communication networks.

### BACKGROUND

Multicasting is the transmission of data to more than one recipient and is a communications primitive of considerable importance in computer networks. While multicasting is useful for a variety of applications (e.g., audio and video streaming, shared group communications, and so forth), multicast service has greatly lagged that of traditional unicast service in the Internet. For example, the Internet still has no standard means of allowing an Internet-wide multicast transmission and nearly all Internet Service Providers currently prohibit most multicast traffic (e.g., with the exception of their own Internet TV services and for support for engineered Enterprise virtual private networks (VPNs)). Some reasons for the lack of multicast support by commercial carriers include the absence of a suitable cost model for multicast traffic, as well as the overhead of supporting multicast traffic in terms of forwarding state (since each of the forwarding elements in paths of the multicast flows needs to have forwarding state installed and this forwarding state typically cannot be aggregated as in the case of unicast flows, which makes multicast forwarding state unscalable). As such, multicast is currently an Enterprise technology, rather than an Internet technology. This is of some concern since the current method of group communication in public networks, such as the Internet, is based on unicast replication at the source, which is vastly more inefficient in terms of bandwidth utilization than multicast.

### SUMMARY

The present disclosure generally discloses multicast communication support capabilities.

In at least some embodiments, an apparatus is provided. The apparatus includes a processor and a memory communicatively connected to the processor. The processor is configured to receive, at a first switch of a multicast tree of a multicast group, a multicast packet including a header and a payload, the header including a destination address field including a multicast destination address of the multicast group. The processor is configured to modify the multicast packet at the first switch of the multicast tree, to form thereby a modified packet, by updating the destination address field of the header to include a unicast destination address of a second switch of the multicast tree and adding the multicast destination address of the multicast group to the header. The processor is configured to send the modified packet toward the second switch of the multicast tree.

In at least some embodiments, an apparatus is provided. The apparatus includes a processor and a memory communicatively connected to the processor. The processor is configured to receive, at a switch of a multicast tree, a packet including a header and a payload, the header including a destination address field including a unicast destination address of the switch, the header further including a multicast destination address of a multicast group associated with the multicast tree. The processor is configured to generate, at the switch of the multicast tree based on the packet, a set of modified packets associated with respective branches of the multicast tree, the modified packets including respective headers and payloads, the respective headers of the modified packets including respective destination address fields including respective unicast destination addresses of respective switches associated with the respective branches of the multicast tree, the respective headers of the modified packets each including the multicast destination address of the multicast group associated with the multicast tree. The processor is configured to send the modified packets toward the respective switches associated with the respective branches of the multicast tree.

In at least some embodiments, an apparatus is provided. The apparatus includes a processor and a memory communicatively connected to the processor. The processor is configured to receive, at a switch of a multicast tree of a multicast group, a packet including a header and a payload, the header including a destination address field including a unicast destination address identifying the switch of the multicast tree, the header including a multicast destination address of the multicast group. The processor is configured to modify the packet at the switch of the multicast tree, to form thereby a modified packet, by updating the destination address field to include the multicast destination address of the multicast group. The processor is configured to send the modified packet toward a destination node of the multicast group.

In at least some embodiments, an apparatus is provided. The apparatus includes a processor and a memory communicatively connected to the processor. The processor is configured to determine, at a control element, a flow forwarding rule for a switch of a multicast tree of a multicast group having a multicast destination address associated therewith. The flow forwarding rule is indicative that, for a packet associated with the multicast group that is received at the switch, the switch is to modify a header of the packet by including a unicast destination address within a destination address field of the packet and by including the multicast destination address of the multicast group within the header. The processor is configured to send the flow forwarding rule toward the switch of the multicast tree.

### BRIEF DESCRIPTION OF THE DRAWINGS

The teachings herein can be readily understood by considering the following detailed description in conjunction with the accompanying drawings, in which:

FIG. 1 depicts an example communication system for illustrating various multicast communication support capabilities;

FIG. 2 depicts an embodiment of a method for providing a unicast branching based multicast tree by determining the unicast branching based multicast tree and establishing the unicast branching based multicast tree;

FIG. 3 depicts an embodiment of a method for determining a unicast branching based multicast tree, for use in the method of FIG. 2;

FIGS. 4A-4B depict example configurations for illustrating methods for determining a set of branching switches for a unicast branching based multicast tree based on a Steiner tree problem;

FIG. 5 depicts an example reduction of a set cover problem for illustrating methods for determining a set of branching switches for a unicast branching based multicast tree based on a Constrained Minimum Cost Configuration problem;

FIG. 6 depicts an embodiment of a method for establishing a unicast branching based multicast tree, for use in the method of FIG. 2;

FIG. 7 depicts an embodiment of a method for use by a switch for forwarding packets within a unicast branching based multicast tree;

FIG. 8 depicts an example unicast branching based multicast tree for a multicast group;

FIGS. 9A-9C depict example packet formats for packets forwarded via the unicast branching based multicast tree of FIG. 8; and

FIG. 10 depicts a high-level block diagram of a computer suitable for use in performing various functions described herein.

To facilitate understanding, identical reference numerals have been used, where possible, to designate identical elements that are common to the figures.

### DETAILED DESCRIPTION

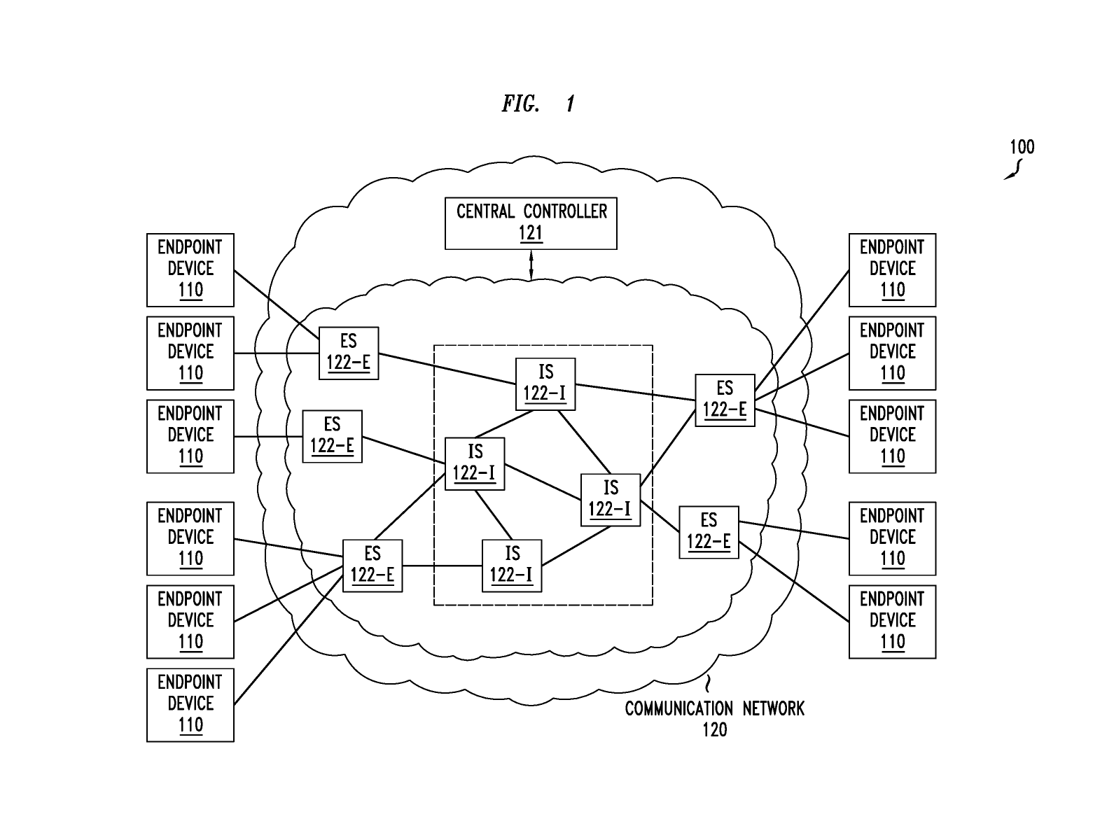

The present disclosure generally discloses multicast communication support capabilities. The multicast communication support capabilities may be configured to support multicast communications of a multicast group using a multicast tree. The multicast communication support capabilities may include a unicast branching based multicast capability (which also may be referred to herein as a unicast branching capability). The unicast branching capability may be configured to support determination and establishment of, as well as communication via, a multicast tree that is composed of unicast branches. The unicast branching capability is configured to preserve the multicast information of multicast transmissions transported via the multicast tree (e.g., multicast destination address or other multicast information) even though the multicast transmissions are transported via unicast branches of the multicast tree. The unicast branching capability may be configured to support scalable multicast via a multicast tree in a centrally controlled network (e.g., a software defined network (SDN), which may be based on Open Flow or other suitable SDN technologies, or other suitable types of centrally controlled networks) in a manner that (1) obviates the need to maintain per-multicast forwarding state at each of the forwarding elements of the data plane by restricting the multicast forwarding state in the data plane to a selected subset of compliant forwarding elements of the data plane which may be referred to herein as unicast branching switches (or more generally, as unicast branching nodes or branching nodes) and (2) obviates the need for using tunnels to interconnect the forwarding elements that will operate as the branching nodes of the multicast tree since branching nodes of the multicast tree will be communicatively connected by unicast branches of the multicast tree. The multicast communication support capabilities may be configured to support multicasting in various types of communication networks and at various communication network layers (e.g., for multicasting at the Ethernet layer (L2), the Segment Routing layer (L2.5), the Internet Protocol (IP) layer (L3), within content distribution and streaming networks (L5), or the like). It is noted that various embodiments of the multicast communication support capabilities may enable use of multicasting in Segment Routing enabled networks that do not currently support multicasting. It will be appreciated that, while various embodiments of the multicast communication support capabilities are primarily presented within the context of a particular type of centrally controlled network (namely, an OpenFlow based SDN), various embodiments of the multicast communication support capabilities also may be provided using other types of centrally controlled networks (e.g., SDN networks using a control protocol other than OpenFlow, networks providing central control using technologies other than SDN, or the like). It will be appreciated that, while various embodiments of the multicast communication support capabilities are primarily presented within the context of a particular type of multicasting (namely, point-to-multipoint (P2MP) multicasting in which the multicast traffic originates from a single source and is disseminated in the form of a tree to various destinations that constitute the multicast group), various embodiments of the multicast communication support capabilities also may be provided for other types of multicasting (e.g., multipoint-to-point (MP2P) multicasting (which may be viewed as an inverted version of P2MP multicasting), multipoint-to-multipoint (MP2MP) multicasting (which may be viewed as a collection of P2MP trees), or the like). These and various other embodiments and advantages of the multicast communication support capabilities may be further understood by way of reference to the communication system of FIG. 1.

FIG. 1 depicts an example communication system for illustrating various multicast communication support capabilities.

The communication system 100 includes a set of endpoint devices (EDs) 110-1-110-N (collectively, EDs 110) and a communication network (CN) 120.

The EDs 110 include devices which may operate as endpoints of multicast communications. The EDs 110 may operate as multicast sources or as multicast destinations (certain EDs 110 may operate as multicast sources and multicast destinations, while certain EDs 110 may operate only as multicast sources or only as multicast destinations). The EDs 110, when operating as multicast sources, may be configured to request establishment of multicast groups and associated multicast trees. The EDs 110, when operating as multicast destinations, may be the ultimate receivers of content transported by the multicast communications or may further propagate content transported by the multicast communications. The EDs 110, when operating as multicast destinations, may be configured to join multicast groups and associated multicast trees and to leave multicast groups and associated multicast trees. For example, the EDs 110 may include end devices (e.g., smartphones, tablet computers, laptop computers, set-top-boxes (STBs), televisions, machine-type-communication (MTC) devices, Internet-of-Things (IoT) devices, or the like), network devices (e.g., edge devices of a network or service provider, edge devices within an enterprise network or the like), or the like. The EDs 110 may be configured to support various other functions. It will be appreciated that, although primarily presented with respect to specific numbers and arrangements of the EDs 110, various other numbers or arrangements of the EDs 110 may be used.

The CN 120 is a communication network that is configured to support unicast and multicast communications of EDs 110. As discussed herein, the multicast communications may be supported using multicast trees established for multicast groups (where each of the multicast groups may include a set of EDs 110 as its members, respectively). The CN 120, as discussed further below, is configured to support multicast trees that are based on unicast branching. In general, a multicast tree that is based on unicast branching is composed of unicast branches (in which packet forwarding is based on unicast destination address information) and includes one or more switches operating as branching switches (at which an incoming flow is mapped to multiple outgoing flows such that there is branching at that point of the multicast tree) and may include zero or more switches operating as pass-through switches (at which an incoming flow is mapped to a single outgoing flow such that there is no branching at that point of the multicast tree). It will be appreciated that the multicast communications may be used for transport of various types of content (e.g., text, audio, video, multimedia, software, or the like, as well as various combinations thereof).

The CN 120 may be configured to support typical Ethernet and Internet Protocol (IP) network capabilities and associated unicast and multicast packet formats. It is noted that, while typical Ethernet and IP network capabilities and associated unicast and multicast packet formats will be understood, at least some properties related to typical Ethernet and IP network capabilities and associated unicast and multicast packet formats are discussed further for purposes of completeness. For example, it is assumed that unicast packets and multicast packets have different address spaces, that multicast groups are identified by their multicast destination addresses, and that multicast sources send multicast packets using their unicast source addresses and the respective multicast destination addresses of the multicast groups of the respective multicast sources (e.g., in a P2MP multicast setup for a multicast group, there is a single multicast source, having an associated unicast source address, that is sending multicast packets to a given multicast destination address of the multicast group). Additionally, for example, it is assumed that the EDs 110 belong to a common network under a single administrative control (e.g., an Internet Service Provider (ISP)). Additionally, for example, it is assumed that at least the edge devices of the CN 120 are capable of rewriting source and destination address fields in incoming packets and outgoing packets. It is noted that at least some of the above assumptions may be changed in various ways (at least some of which are addressed further below) in various contexts or under various conditions

The CN 120 may be configured to use software defined networking (SDN) capabilities for centralized control of CN 120. The SDN capabilities may be provided using OpenFlow or other suitable SDN solutions. In general, OpenFlow is a standard protocol used by controllers to install forwarding state in switches in an SDN network by setting various rules (e.g., flow or packet matching rules) in tables of the switches. In general, switches using OpenFlow may include Flow Tables and Group Tables, where a standard OpenFlow Flow Table entry is generally used to match an incoming flow and transform the incoming flow into a single outgoing flow and where a standard OpenFlow Group Table entry allows an incoming flow to be replicated to form multiple output flows. It is noted that, while a Group Table entry allows an incoming flow to be replicated to form multiple outgoing flows (and, thus, may be particularly well-suited for handling multicast flows), the incoming flow as well as the outgoing flows may be of any flow type and do not necessarily need to be multicast. As a result, a Group Table entry may be configured such that both the incoming flow and the replicated outgoing flows may be typical unicast flows (rather than being multicast flows). As discussed further below, this may be used to construct a unicast branching based multicast tree that is composed entirely of unicast branches (e.g., each branching switch of the multicast tree may be configured, via a Group Table, to receive an incoming unicast flow for the multicast tree and replicate the incoming unicast flow as a collection of multiple distinct outgoing unicast flows (one for each of the branches of the multicast tree)). It is noted that at least some of the above assumptions may be changed in various ways (at least some of which are addressed further below) in various contexts or under various conditions.

The CN 120 includes a central controller (CC) 121 and a set of switches 122. The CC 121 is configured to provide a control plane for CN 120, including controlling at least some of the switches 122. The switches 122 are configured to provide a forwarding plane for the CN 120, including handling the forwarding of packets for multicast communications by EDs 110. The switches 122 include edge switches (ESs) 122-E and intermediate switches (ISs) 122-I (which also may be referred to herein as core switches). The ESs 122-E are configured as points of access to the CN 120 for the EDs 110. The ESs 122-E may be ingress (or first-hop) switches for EDs 110 operating as multicast sources and may be egress (or last-hop) switches for EDs 110 operating as multicast destinations. The ISs 122-I are interconnected via various communication links. The ISs 122-I are not directly connected to the EDs 110, but, rather, are connected to the ESs 122-E via various communication links. The ESs 122-E are connected to EDs 110 via various communication links. The switches 122 may be configured to operate as pass-through switches (at which an incoming flow is mapped to a single outgoing flow such that there is no branching at that point of the multicast tree) or branching switches (at which an incoming flow is mapped to multiple outgoing flows such that there is branching at that point of the multicast tree). The switches 122 also may include one or more legacy switches that are not capable of operating as branching switches but which may still form part of multicast trees based on unicast branching (e.g., switches that are capable of routing packets including unicast source and destination addresses, but which may or may not be under centralized control). The switches 122 may include L2 switches, L2.5 switches, L3 switches, L5 switches, or the like, as well as various combinations thereof (which may depend on the layer at which multicasting is to be supported). As noted above, CC 121 may control switches 122 based on SDN capabilities (e.g., using OpenFlow or other suitable SDN-type capabilities) or other suitable centralized control capabilities. The CC 121 is configured to configure switches 122 to support unicast branching based multicast trees for supporting multicast communications of EDs 110 via CN 120. The operation of CC 121 and switches 122 in providing such functions to support unicast branching based multicast trees for supporting multicast communications of EDs 110 via CN 120 is discussed further below.

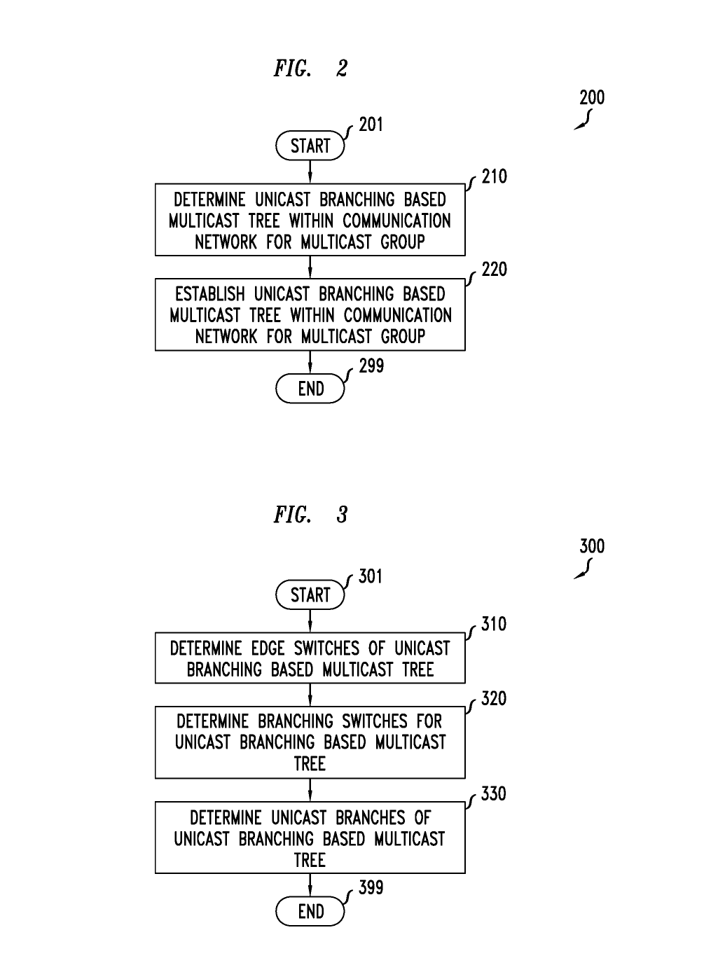

The CC 121, as discussed above, is configured to provide various control functions for CN 120. The CC 121 is configured to control switches 122 of CN 120 to support unicast branching based multicast for multicast communications of EDs 110 via CN 120. The CC 121, for a given multicast group, is configured to determine a multicast tree within CN 120 for the multicast group and to establish (or configure) the multicast tree within the CN 120 for the multicast group. The CC 121 may determine the multicast tree within CN 120 based on multicast group membership information (e.g., the source of the multicast tree and the destinations of the multicast tree), communication network information associated with CN 120 (e.g., topology information describing the topology of CN 120, switch capability information indicative of the capabilities of the switches 122 of CN 120, or the like), or the like, as well as various combinations thereof. The CC 121 may determine the multicast tree within the CN 120 by identifying ingress and egress switches 122 of the multicast tree (which, it will be appreciated, include ESs 122-E associated with source and destination endpoints of the multicast tree), selecting a set of switches 122 to be branching switches of the multicast tree, and determining a set of unicast branches between switches 122 for the multicast tree. The CC 121 may establish the multicast tree within the CN 120 by determining rules (and/or other multicast state information) for switches 122 of the multicast tree and by installing the rules (and/or other multicast state information) for the switches 122 of the multicast tree into the switches 122 of the multicast tree (which, as discussed further below, may include only a subset of the switches 122 of which the multicast tree is composed). The operation of CC 131 in supporting unicast branching based multicast within CN 120 may be further understood by way of reference to FIGS. 2-6 and the example of FIG. 8. It will be appreciated that the CC 121 may be configured to support various other functions.

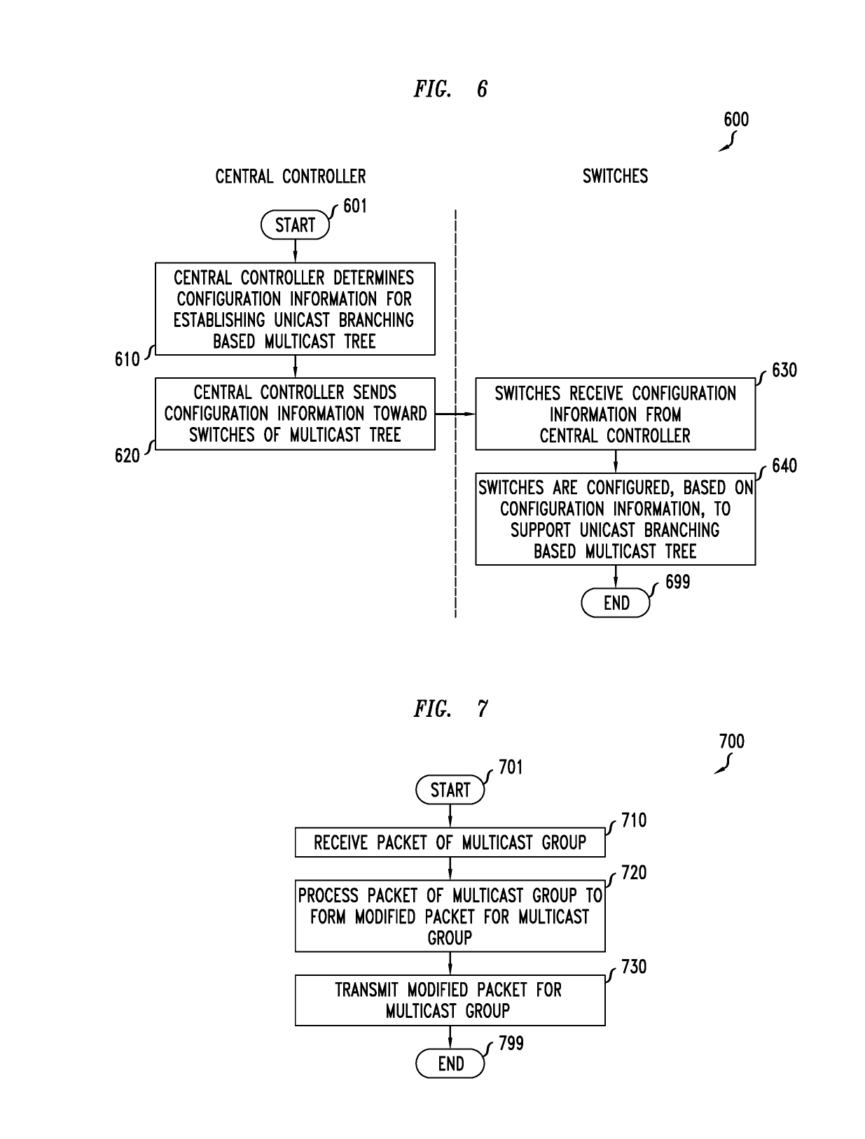

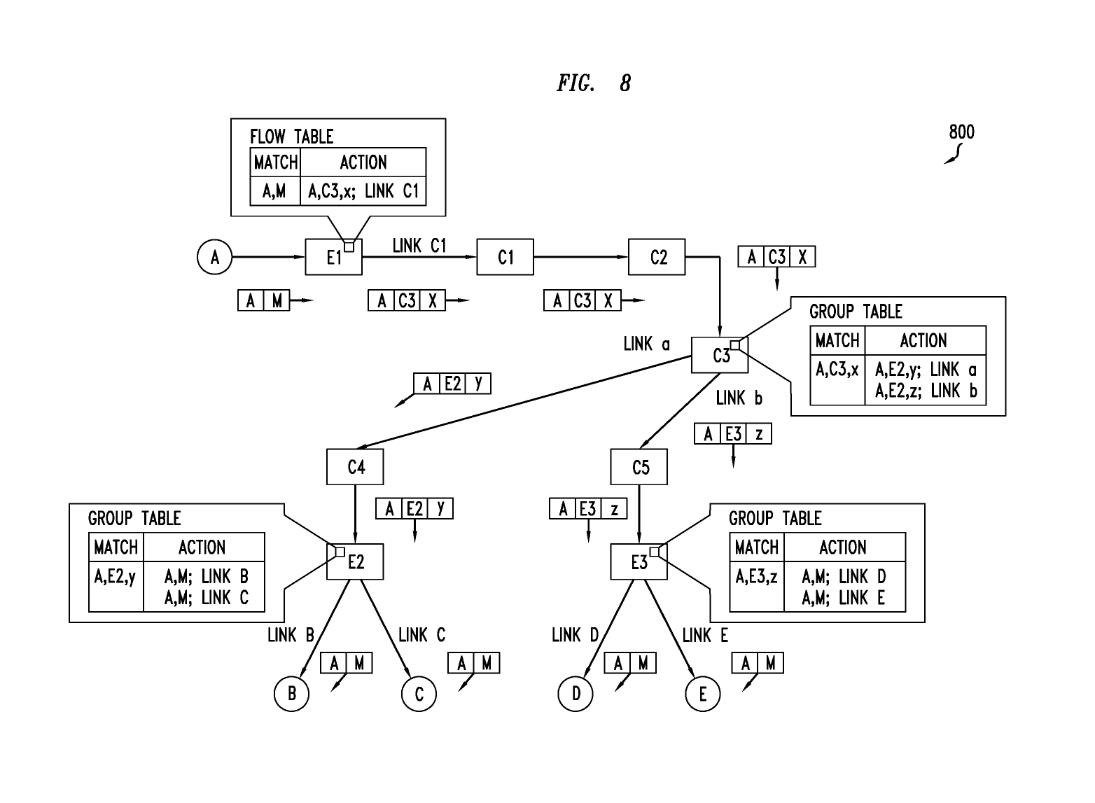

The switches 122, as discussed above, are configured to provide various packet forwarding functions within CN 120. The switches 122 may support multicast communications of EDs 110 via unicast branching based multicast trees established within CN 120 under the control of CC 121. The switches 122 (or at least some of the switches 122) may be configured, under the control of the CC 121 as discussed above, to support unicast branching based multicast trees for multicast communications of EDs 110 via the installation of rules (and/or other multicast state information) into switches 122 by CC 121. The switches 122 of a unicast branching based multicast tree may include zero or more pass-through switches 122 at which an incoming unicast flow is mapped to a single outgoing unicast flow such that there is no branching at that point of the multicast tree (e.g., it is possible that all switches 122 of a unicast branching based multicast tree are branching switches for the multicast tree). The switches 122 of a unicast branching based multicast tree may include one or more branching switches 122 at which an incoming unicast flow is mapped to multiple outgoing unicast flows such that there is branching at that point of the multicast tree (e.g., by receiving an incoming unicast flow for the multicast tree and replicating the incoming unicast flow as a collection of multiple distinct outgoing unicast flows (one for each of the branches of the multicast tree)). The switches 122 of a unicast branching based multicast tree, as discussed further below, may be configured to perform various functions (e.g., re-writing destination addresses of packets of the multicast group, replicating packets of the multicast group, encoding information within packets of the multicast group, or the like, as well as various combinations thereof) depending on their location (e.g., ingress, intermediate, egress) and role (e.g., branching switch or pass-through switch) within the unicast branching based multicast tree. It is noted that, in certain types of networks (e.g., Ethernet, IP, or the like), the use of unicast branches to provide the multicast tree would result in loss of the multicast destination address of the packets transported via the multicast tree (due to the use of unicast addresses for unicast routing on the unicast branches) and, as a result, in at least some embodiments, switches 122 may be configured to process the packets transported via the multicast tree in a manner for preserving the multicast destination address of the packets transported via the multicast tree (e.g., outgoing packets at the ingress points into the multicast tree may be processed to retain the multicast destination address and incoming packets at the egress points out of the multicast tree may be processed to recover the multicast destination address). The manner in which the multicast destination address of packets transported via the multicast tree is preserved, as discussed further below, may vary for different types of networks (e.g., Ethernet, IP, or the like). It is noted that, since the unicast flow on each unicast branch of the multicast tree uses a unicast destination address identifying the tail of the respective unicast branch, switches 122 operating as pass-through switches 122 in the multicast tree do not require explicit state information configured thereon. The operation of switches 122 in supporting unicast branching based multicast may be further understood by way of reference to FIGS. 6-7 and the example of FIG. 8.

It will be appreciated that, although primarily presented with respect to a specific arrangement of communication system 100 (e.g., specific numbers and arrangements of EDs 110, a specific configuration of CN 120, and the like), communication system 100 may be arranged in various other ways while still supporting various embodiments of the unicast branching based multicast capability (e.g., using fewer or more EDs 110, using EDs 110 arranged in other ways, using fewer or more switches 122, using switches 122 arranged in other ways, or the like, as well as various combinations thereof).

FIG. 2 depicts an embodiment of a method for providing a unicast branching based multicast tree by determining the unicast branching based multicast tree and establishing the unicast branching based multicast tree. It is noted that method 200 of FIG. 2 may be executed by a central controller (e.g., CC 121 of FIG. 1). It will be appreciated that, although primarily presented as being performed serially, at least a portion of the functions of method 200 may be performed contemporaneously or in a different order than as presented in FIG. 2.

At block 201, method 200 begins.

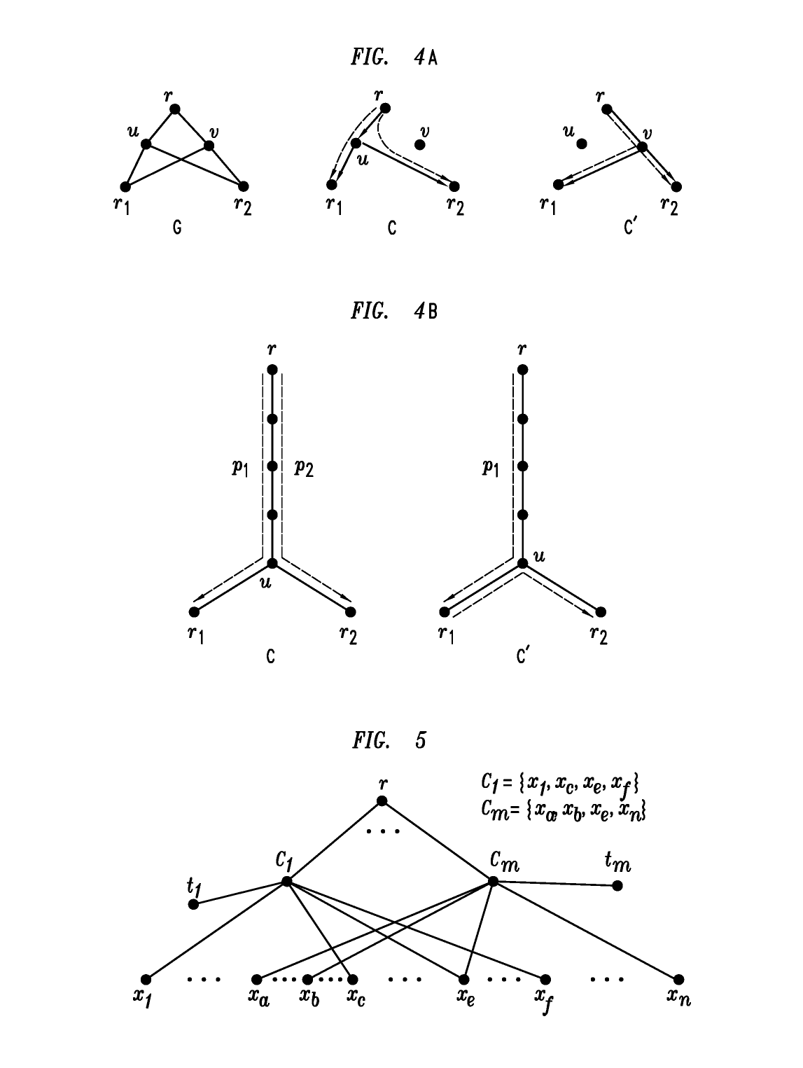

At block 210, a unicast branching based multicast tree is determined within a communication network for a multicast group. The multicast tree may be determined based on endpoint information of the multicast tree (e.g., an identification of the source of the multicast tree and the destinations of the multicast tree), topology information describing the topology of the switches of the communication network, capability information describing capabilities of the switches of the communication network (e.g., whether or not the switches are legacy switches which may only operate as pass-through switches for the multicast tree or are configured to operate as pass-through or branching switches for the multicast tree), or the like, as well as various combinations thereof. The multicast tree may be determined by determining the ingress and egress switches for the multicast tree, determining the set of branching switches for the multicast tree, and determining each of the unicast branches of the multicast tree. An embodiment of a method for determining a unicast branching based multicast tree is presented in FIG. 3.

At block 220, the unicast branching based multicast tree is established within the communication network for the multicast group. The multicast tree may be established within the communication network by determining (at a central controller) configuration information for use in configuring switches of the multicast tree to support the multicast tree and providing the configuration to the switches of the multicast tree so as to configure the switches of the multicast tree to support the multicast tree. This may include determination of state information (e.g., packet processing rules or other state information) by a central controller and installation of the state information onto the switches of the multicast tree. An embodiment of a method for establishing a unicast branching based multicast tree is presented in FIG. 6.

At block 299, method 200 ends.

FIG. 3 depicts an embodiment of a method for determining a unicast branching based multicast tree, for use in the method of FIG. 2. It is noted that method 300 of FIG. 3 may be executed by a central controller (e.g., CC 121 of FIG. 1). It will be appreciated that, although primarily presented as being performed serially, at least a portion of the functions of method 300 may be performed contemporaneously or in a different order than as presented in FIG. 3.

At block 301, method 300 begins.

At block 310, edge switches of the unicast branching based multicast tree are determined. The edge switches of the multicast tree include an ingress switch for the multicast tree (the point at which the multicast tree enters the communication network) and egress switches for the multicast tree (the points at which the multicast tree exits the communication network). The edge switches of the multicast tree may be determined based on the endpoint information of the multicast group (e.g., an identification of the source of the multicast group and the destinations of the multicast group), topology information describing the topology of the switches of the communication network (e.g., indications of switches of the communication network providing network access to the communication network for specific endpoints of the multicast group), or the like, as well as various combinations thereof. It will be appreciated that the endpoint information of the multicast group (e.g., the set membership of the multicast group) may be determined based on an a priori configuration known for static multicast groups, may be determined based on multicast group membership requests (e.g., which may be intercepted by the ingress switches that are associated with endpoints of the multicast group and forwarded by those ingress switches to the central controller) for dynamic multicast groups, or the like. The edge switches of the unicast branching based multicast tree may be determined based on various other types of information.

At block 320, a set of branching switches for the multicast tree is determined. The set of branching switches for the multicast tree may be determined by selecting the set of branching switches for the multicast tree from a set of candidate branching switches of the communication network available for selection as branching switches for the multicast tree. The set of branching switches for the multicast tree may be determined in various ways.

In at least some embodiments, the set of branching switches for the multicast tree may be determined based on a manual selection of the branching switches for the multicast tree. The manual selection may be performed at the time of determining the multicast tree, may be preselected and stored in memory (and, thus, determined at the time of determining the multicast tree by retrieving the set of branching switches for the multicast tree from the memory), or the like, as well as various combinations thereof.

In at least some embodiments, the set of branching switches for the multicast tree may be determined by selecting the set of branching switches for the multicast tree from a set of candidate branching switches available in the communication network.

In at least some embodiments, the set of branching switches for the multicast tree may be selected from a set of candidate branching switches available in the communication network based on application of the Steiner tree problem. In this embodiment, the communication network may be modeled as a graph, with each switch of the communication network being mapped to a node of the graph and each link of the communication network being mapped to an edge of the graph. Here, as indicated above, a given P2MP multicast group maps to a source node and a set of destination nodes of the graph. The cost of each link for transmitting a packet can be mapped to edge weights in the graph. In this embodiment, the set of branching switches for the multicast tree may be selected from the set of candidate branching switches by determining, from the graph, a minimum cost configuration (which may or may not be a tree) that spans the switches of the multicast tree with a minimum possible total edge weight. As noted above, this may be considered to be an application of the Steiner tree problem (the optimal solution of which is known to be NP complete) to select the set of branching switches.

In at least some embodiments, the set of branching switches for the multicast tree may be selected from a set of candidate branching switches available in the communication network based on a policy-based selection of the branching switches for the multicast tree. Unlike a general Steiner tree as discussed in the preceding embodiment, in which any node in the graph can serve as a branching switch of the tree, policy-based multicast is concerned with the policy-based selection of branching switches for a given multicast group. Policy, however, can dictate that some multicast groups be confined to particular subsets of branching switches if those multicast groups subscribe to certain network services that are only available at those branching switches. This potential variability of policy for use in policy-based selection of branching switches for a given multicast group may have various results and, thus, may be handled using various embodiments (e.g., a Steiner tree problem based embodiment discussed further below and presented with respect to FIGS. 4A-4B and a Constrained Minimum Cost Configuration problem based embodiment discussed further below and presented with respect to FIG. 5).

In at least some embodiments of the policy-based selection of the branching switches for the multicast tree, given a set of candidate branching switches for a given multicast group, the minimal set of branching switches that can provide a minimum cost tree may be determined. In at least some such embodiments, this determination (or problem) can be mapped into the Steiner tree problem (such that it is possible to make use of the result that there is a polynomial time approximation algorithm for finding a valid configuration with a cost that is, at most, 1.39 times the cost of a minimum cost valid configuration. This embodiment is further depicted and described with respect to FIGS. 4A-4B, which depict example configurations for illustrating methods for determining a set of branching switches for a unicast branching based multicast tree based on a Steiner tree problem.

In at least some embodiments of the policy-based selection of the branching switches for the multicast tree, if there is no limitation on the set of candidate branching switches for a given multicast group, the minimal set of branching switches that can provide a minimum cost tree may be determined. This may be referred to as the Constrained Minimum Cost Configuration problem, which also is NP-complete. This embodiment is further depicted and described with respect to FIG. 5, which depicts an example reduction of a set cover problem for illustrating methods for determining a set of branching switches for a unicast branching based multicast tree based on a Constrained Minimum Cost Configuration problem.

The embodiments of the policy-based selection of the branching switches for the multicast tree may be further understood by first considering a graph representing a destination-based forwarding network and the problem of efficiently routing a multicast demand in a destination-based forwarding network.

In a destination-based forwarding network, the problem of efficiently routing a multicast demand is typically stated in terms of a Steiner tree problem. That is, when the goal is to find the smallest subgraph connecting a source (root) node with a set of target nodes, thus minimizing the total traffic due to the demand, then this can easily be stated directly as a Steiner tree problem.

In a path switching network, it may be shown that the problem of efficiently routing a multicast demand, while different from the problem in a destination-based network, is still related to the Steiner tree problem. The application of the Steiner tree problem to a path switching network may be further understood by first considering a connected graph and an associated multicast demand, capabilities of the nodes within the connected graph, and a path through the connected graph.

The application of the Steiner tree problem to a path switching network, as noted above, may be further understood by considering a connected graph and an associated multicast demand. Let G=(V, E) be a connected graph. A multicast demand d on G is a tuple d=(r, r₁, r₂, . . . rₜ) where r is called the root and r1, r2, . . . , rt are the target nodes. Here, R={r, r1, r2, . . . , rt} is referred to as the set of root/target nodes.

The application of the Steiner tree problem to a path switching network, as noted above, may be further understood by considering the capabilities of nodes of the connected graph. For example, some nodes are permitted to create packets while other nodes are only permitted to pass along each arriving packet according to the encoded path in the header of the packet. The nodes that can create packets are referred to as originator nodes and the nodes that cannot create packets are referred to as transit nodes. Let O denote the set of originator nodes. It is assumed that R ⊂ O. The set X=O \R is called the set of extra originator nodes.

The application of the Steiner tree problem to a path switching network, as noted above, may be further understood by considering a path through the connected graph. Here, the notation p=v₁v₂ . . . vₕ may be used to denote a path p that consists of arcs vᵢvᵢ+1,1≦i <h.

The Steiner tree problem, when applied to a path switching network, may be stated as follows. The input to a Steiner tree problem is an edge-weighted graph H=(O, F) and a subset U ⊂ O of the nodes. The goal is to find a tree T in H whose total edge weight is the minimum possible such that the tree spans the nodes of U.

The Steiner tree problem, when applied to a path switching network, also may be used to address the problem of satisfying multicast demands using path switching. When a packet q reaches an originator node v (or v is the root node), v can create any number of packets that are identical to q with the exception that the respective headers include different path encodings (for the different multicast branches to be traversed). Then, each such replicated packet travels along the path encoded in its header. It is noted that each such path encoded in a packet should be a path to some originator node since, if a path ended at a transit node, it would just stop there and would not reach a target node. The goal then is to define what path encodings each originator node should encode in outgoing packets to ensure that, for each target node, some packet reaches that target node. Clearly then a trivial solution for any multicast demand would be to simply have the root node create for each target node, a packet whose header contains a path encoding of a path from the root to that target node. Such a solution is really just unicasting to each target node, most likely resulting in an unnecessarily high load on the network. Accordingly, in at least some embodiments, path switching may be used to address the problem of satisfying multicast demands while creating as little traffic as possible on the network. The use of path switching to address the problem of satisfying multicast demands while creating as little traffic as possible on the network may be further understood by first considering a more formal definition of the notion of a solution for a multicast demand using path switching.

The notion of a solution for a multicast demand using path switching may be more formal defined as follows, which includes a definition of a configuration and a definition of an action of a configuration.

A configuration C is defined by giving for each b ∈ O a set, P_{C}(b), of paths where each such path is a path from b to some other originator node b′. Let P_{C}=U_{b∈O}P_{C}(b). A configuration C is said to be a complete configuration for multicast demand d=(r, r₁, r₂, . . . , rₜ) if, for each target node rᵢ, there is a path pᵢ from r to rᵢ such that pᵢ is a concatenation of some sequence of paths each of which is in P_{C}.

An action of a configuration C is defined as follows. A packet q is injected at r and then, for each path p ∈ P_{C}(r), a packet whose body is the same as the body of packet q, but with the encoding of p in its header, exits r along the first edge of p. Then, as a packet enters an originator node b, a copy of the packet with the encoding of p in its header exits b along the first edge of p for each path p ∈ P_{C}(b). Thus, in a complete configuration, for each packet q starting at r, a replica packet of q reaches each target node rᵢ.

As mentioned above, it is known that a trivial complete configuration always exists for a multicast demand. However, it will be seen that some complete configurations are better than others in that they result in less network traffic. In order to quantify the quality of complete configurations, and to enable comparisons of complete configurations with respect to each other, the cost(C) of a configuration C may be defined as follows. For a path p, let |p| be the number of edges in p. Then, the cost(C) of a configuration C may be defined as cost(C)=Σ_{p∈P}_{_{C}}|p|.

For example, in FIG. 4A, the graph G is as shown and the node v is an originator node while node u is not. For demand d=(r, r₁, r₂), consider the configuration C with P_{C}(r)={rur₁, rur₂}. Thus cost(C)=|rur₁|+|rur₂|=2+2=4. The equivalent way to look at cost is to consider the action of C where, when node u receives a packet from node r with an encoding of path rurᵢ, it sends it out on arc urᵢ. Thus, this results in two packets sent on ru and one each on ur₁ and ur₂ for a total of four packets. On the other hand, consider another complete configuration C′ that takes advantage of the fact that v is an originator node. In C′ we have P_{C′}(r)={rv} and P_{C′}(v)={vr₁, vr₂}. In this case, cost(C′)=3.

It is noted that the definition of a complete configuration provided above does not necessarily restrict the configuration so that the paths in P_{C} form a multicast tree (that is, where edges traversed by packets form an out-arborescence rooted at r). An example illustrating the reason for considering more general configurations than those that form a multicast tree is depicted in FIG. 4B. In particular, this example shows that, if the configuration is restricted to a multicast tree, then the cost of a solution may not be optimal. In the example, the only originator nodes are the root/target nodes r, r₁ and r₂ and, thus, the only complete configuration that results in a multicast tree is the configuration C where P_{C}(r)={p₁, p₂} (where pᵢ is the simple path from r to r₁, i=1, 2). It is noted that cost(C)=10. However, if a more general configuration is permitted, such as C′ where P_{C′}(r)={p₁} and P_{C′}(r₁)={r₁ur₂}, then this results in traffic on both edges of the directed cycle ur₁u, but cost(C′)=7 (which is less than the cost of any multicast tree solution).

Let C be a complete configuration and let PC={p: p ∈ U_{b∈O}P_{C}(b)}. It may be assumed that, if p ∈ P_{C}(b) where p is a path from b to b′, then for all v ∈ p where v≠b, b′, b ∉ O. This assumption is without loss of generality since, if such a v is in O, then we could replace p in P_{C}(b) with p₁ and add p₂ to P_{C}(b′) where p₁ is the path segment of p from b to v and p₂ is the path segment of p from v to b′ and we would still have a complete configuration with the same cost as C.

Given a complete configuration, a directed graph D_{C}=(O, AC) may be built as follows. For each p ∈ P_{C} add an arc s(p)f(p) ∈ A_{C} where s(p) ∈ O is the starting node of p, f(p) ∈ O is the final node of p. Similarly, without loss of generality, it may be assumed that D_{C} contains no directed cycle since cycles can be broken by removing paths from P_{C} thus lowering the cost but keeping the configuration complete. It is noted that such a complete configuration C is called an acyclic configuration.

In an acyclic configuration C, it may be assumed that, for each target node rᵢ, there is a unique path pᵢ^{C} from r to rᵢ that is a concatenation of paths in P_{C}. It will be appreciated that, if there is a path p ∈ P_{C} such that p is not the part of any pᵢ^{C}, then it can be removed and a complete configuration is still obtained (and, further, that the complete configuration costs less than C). It is noted that such a configuration is called a minimal configuration.

In a minimal configuration C, without loss of generality, it may be assumed that, for each p ∈ P_{C}, p is a shortest path between its endpoints since, otherwise, it could be replaced by paths whose concatenation does form a shortest path without increasing the cost of the configuration. It is noted that such a configuration is called a valid configuration.

It will be appreciated that, in the discussion above, it has been assumed that the network is given by a graph G=(V, E). However, in some instances, graph G may be considered to be a directed graph in which every edge {u, v} ∈ E is replaced with the two oppositely directed edges (i.e., arcs) uv and vu. Then, an interpretation of the cost of a configuration C is that cost(C) is the sum of the number of packets over all the edges due to the action of C. Thus, the goal becomes finding a valid configuration of minimum cost since that will minimize the total traffic in the network due to the multicast demand.

As discussed above, the problem of finding a minimum cost valid configuration in G for a given multicast demand may be viewed as a problem of finding a minimum cost Steiner tree in a graph derived from G. This problem may be defined as follows.

Let H=(O, F) where there is an edge bb′ ∈ F if and only if there is a shortest path p between b and b′ in G such that if v ∈ p and v≠b, b′ then v ∉O. Here, a weight w(b, b′)=|p| is put on edge bb′.

Let T_{C} be D_{C} be defined as above with directed edges replaced by undirected edges. Then, by the definition of a valid configuration, T_{C} is a subtree of H that spans the root/target nodes. That is, it is a Steiner tree for terminal set R. Thus, T is a minimal Steiner tree if, for every edge e ∈ T, it is determined that T \ {e} is not a Steiner tree. The weight (T_{C}) may be defined as the sum of the weights of the edges of T_{C} in H.

A minimum cost valid configuration in G for a given multicast demand, which may be viewed as a problem of finding a minimum cost Steiner tree in a graph derived from G, may be computed as follows. For graph G with a set of originator nodes, a minimum cost valid configuration C for demand d=(r, r₁, r₂, . . . , rₜ) is determined. It may be shown that the problem is approximable (APX)-hard, but has a polynomial time 1.39-approximation algorithm. Accordingly, as indicated above, the valid configuration problem may be transformed into a Steiner Tree problem as follows.

First, consider a theorem (denoted as Theorem 1) which states that there is a valid configuration C with cost(C)=c if and only if there is a minimal Steiner tree T in H with weight(T_{V})=c. A proof of this theorem follows. Let T_{C} be constructed from D_{C} as described above. Since each path in P_{C} is a shortest path containing nodes from O only at its endpoints, TC ∈ H. Since C is acyclic and minimal so is T_{C}. Also, T_{C} must be connected and span R since C contains paths from r to each target node rᵢ. That is, T_{C} is a Steiner tree in H for terminal set R. Since the weight on the an edge of T_{C} is the length of the shortest path between the originator nodes that are the endpoints of the edge, the sum of the edge weights is the sum of the lengths of the paths in P_{C} and so weight(TC)=cost(C).

Now, consider some Steiner tree T ∈ H. From T it may be shown how to construct a valid configuration C by describing the paths in P_{C}. The edges of T may be directed so that T becomes an out-arborescence rooted at r. For each directed edge e=(b, b′) of T the following is performed. By definition of H, there is a shortest path pₑ in G from b to b′ of length weight(e). Add pₑ to P_{C}(b) and hence to P_{C}. Therefore, the cost(C) is then exactly weight(T). Since T spans R, C, as defined by P is a complete configuration. Also, C is an acyclic configuration since T is a tree. It follows that, since T is minimal, so is C. Finally, C is a valid configuration since each pₑ is a shortest path.

Now, consider a minimum cost Steiner tree T*. It will be appreciated that a minimum cost Steiner tree must be minimal (since, otherwise, removing an edge that leaves it a Steiner tree would have lower cost). There is a polynomial time algorithm for finding a minimal Steiner tree Tₐₚₚᵣₒₓ such that weight(Tₐₚₚᵣₒₓ)≦1.39*weight(T*). Thus, together with Theorem 1, it may be concluded that there is a polynomial time approximation algorithm for finding a valid configuration whose cost is at most 1.39 times the cost of a minimum cost valid configuration (which, as discussed below, may be considered to be another theorem).

Next, as indicated above, consider a theorem (denoted as Theorem 2) which states that there is a polynomial time approximation algorithm for finding a valid configuration whose cost is at most 1.39 times the cost of a minimum cost valid configuration. Here, it is noted that it may be shown that the problem of finding a minimum cost valid configuration is APX-hard by considering the details of the construction showing that the problem of finding a minimum cost Steiner tree is APX-hard (which, again, may be considered to be another theorem).

Next, as indicated above, consider a theorem (denoted as Theorem 3) which states that finding a minimum cost valid configuration is APX-hard. A proof of this theorem follows. It will be appreciated that the problem of finding a minimum cost Steiner tree is APX-hard. In fact, it will be appreciated that the problem of finding a minimum cost Steiner tree is APX-hard in the special case where the graph H=(O, F) in question is a complete graph where the cost of each edge is 1 or 2. Clearly, for every such instance of the Steiner tree problem, it is possible to construct an instance of the problem of finding a minimum cost valid configuration since the edge costs satisfy the triangle inequality. In particular, it is possible to create an instance of the valid configuration problem with a graph G=(V, E) whose node set V contains the nodes of O and a dummy node xₑ for every edge e ∈ F with cost 2. The nodes of V that are nodes in O are defined to be the set of originator nodes. For every cost 1 edge in J, there is an edge in E. For every cost 2 edge {u, v} in F, there is a path ux_{{u,v}}v. The root and target nodes are the terminals of the Steiner tree problem (and the root may be chosen arbitrarily from the set of terminals). Then, by Theorem 1, an approximation to the minimum cost valid configuration problem for this instance is an equivalent approximation for the minimum cost Steiner tree problem. Therefore finding a minimum cost valid configuration is APX-hard.

It will be appreciated that the best theoretical approximation algorithms for the minimum weight Steiner tree problem may be somewhat complex; however it should be noted that there is a simple algorithm for approximating the minimum weight Steiner tree problem with an approximation factor of 2−1/|R| where R is the set of nodes that are required to be spanned. Thus, in this case, it would be a factor of 2−1/(t+1) for t target nodes plus the root node. It has been shown that for a minimum Steiner tree instance H=(O, F) where |O|=n, |F|=m and the number of terminals is k, a minimum Steiner tree can be found in O(3^{k}n+2^{k}n²+n² log n+nm) time. Thus, if k is a constant then the Steiner tree problem can be solved exactly in polynomial time (which, as discussed below, may be considered to be another theorem).

Next, as indicated above, consider a theorem (denoted as Theorem 4) which states that, when the number of source/target nodes is a constant, a minimum cost valid configuration can be found in polynomial time. A proof of this theorem follows. This theorem follows from Theorem 1 and the fact that the equivalent Steiner tree instance H=(O, F) with |O|=n and |F|=m can be solved in O(n² log n+nm) time.

The foregoing assumes that the set of extra originator nodes is known a priori. However, in some instances (e.g., for determining branching nodes in unicast branching based multicast), the set of extra originator nodes is not known a priori, but, rather, is determined (e.g., via selection of the extra originator nodes from a set of candidate extra originator nodes). Recall that X=O \ R is the set of extra originator nodes (i.e., X is the set of originator nodes that are not source/target nodes). Here, consider a problem in which the demand d=(r, r₁, r₂, . . . , rₜ) is known (so the set R is fixed), but the set X is not known, Here, given a non-negative integer k, the goal is to find a valid configuration C whose set of extra originator nodes X_{C} where |XC|≦k and C has minimum cost. The decision version of this problem may be stated as: given a graph G=(V, E), a multicast demand d=(r, r₁, r₂, . . . , rₜ), and bounds k and c, determine whether there exists a valid configuration C that satisfies d where |XC|≦k and where cost(C)≦c. This problem may be referred to as constrained minimum cost multipath. It may be shown that, in general, constrained minimum cost multicast is NP-complete (which, again, may be considered to be another theorem).

Next, as indicated above, consider a theorem (denoted as Theorem 5) which states that constrained minimum cost multicast is NP-complete. A proof of this theorem follows. The problem is in NP since the cost, number of extra originator nodes, and validity of a given configuration can be checked in polynomial time. To show it is NP-hard, a reduction from set cover is described. The reduction is illustrated in FIG. 5. An instance I of set cover consists of a set X={x₁, x₂, . . . , xₙ}, a collection C={C₁, C₂, . . . , Cₘ} of subsets of X, and an integer k>0, and the question is whether there exists a subcollection C′ ⊂ C of subsets such that |C′|≦k and where U_{c}_{₁}_{∈C}, C₁=X.

Next, consider an instance M of constrained minimum cost multicast such that M has a solution if and only if I has a solution. The construction will clearly have complexity polynomial in the size of I. Define G=(V, E) where V={r} ∪ {C_{i,}tᵢ: 1≦i≦m} ∪ {xⱼ: ≦j≦n} and where E={rC_{i,}CᵢCᵢ: 1≦i≦, m} ∪ {Cᵢxⱼ ∈ Cᵢ}. Define the set of root/target nodes S={r} ∪ {xⱼ: 1≦j≦n} ∪ {ti: 1≦i≦m} and the set of extra originator nodes B=[Cᵢ: 1≦i≦m). Define demand d=(r, x₁, x₂, . . . , xₙ, t₁, t₂, . . . , tₘ). Here, the goal is to determine whether there is a valid configuration for d in G that contains at most k extra originator nodes and has cost no more than 2m+n. It is noted that each tᵢ is a target node and so, in any valid configuration, there will be a path from r to tᵢ and by construction such a path will pass through Cᵢ. Then, the point of tᵢ is that if Cᵢ “covers” some xⱼ (i.e., Cᵢ is on the path from r to xⱼ in T) then either Cᵢ is an extra originator node or the same edge coming into Cᵢ must be on multiple paths in P_{C} (i.e., one path to t, and another to xⱼ).

Next, further consider the instance M of constrained minimum cost multicast such that M has a solution if and only if I has a solution. It may be shown that there is a solution to the set cover instance I of size at most k if and only if there is a valid configuration costing at most 2m+n and with at most k extra originator nodes.

First, consider the case where there is a size at most k solution C′ to I. For each 1≦j≦n, C₁ⱼ is defined to be the lowest indexed subset in C′ containing xⱼ. It is noted that C₁ⱼ is well-defined since C′ is a solution for I. Define P_{C} as follows: P_{C}(r)={rC₁: 1≦i≦m} and P_{C}(C₁)={C₁Cᵢ} ∪ {Cᵢxⱼ: Cᵢⱼ=C₁}. The configuration C defined by P_{C} can be checked to be valid. Also, C has cost exactly 2m+n since P_{C}(r) consists of m paths of length 1 and the union of all the sets P_{C}(Cᵢ) consists of m+n paths of length 1. It is noted that, if Cᵢ ∉ 2 C′, then P_{C}(Cᵢ)={Cᵢtᵢ} and, thus, is not an extra originator node. Therefore, at most k of the Cᵢ nodes are extra originator nodes since |C′|≦k.

Next, suppose that there is a valid configuration C for d where C′, the set of extra configuration nodes, has cardinality at most k and the cost of C is at most 2m+n. Since C is a valid configuration, for each target node there will be some path in P_{C} having an edge directed into that target node. There are m+n target nodes so these edges account for at least m+n of the total cost (and possibly more if some appear in more than one path in P_{C}). However, to get to tᵢ there must be a path containing Cᵢ, which means that for each Cᵢ there is an edge in some path in P_{C} directed into Cᵢ. These edges account for another m of the cost and, since the total cost is at most wm+n, it must be that each Cᵢ, tᵢ and xⱼ has exactly one edge directed into it in the set of paths in P_{C} and in fact these are the only edges in the paths of P_{C} and each appears in exactly one such path since there are 2m+n of them and the cost is bounded by 2m+n.

It is noted that there will be a path or sequence of paths in P_{C} that leads from r to each tᵢ and, hence, includes Cᵢ. Therefore, if Cᵢ is not an extra originator node, then the path (or sequence of paths) in P that describes a path pⱼ that starts at r and ends at some xⱼ then C₁ will not be on pⱼ. Therefore, for each xⱼ, there will be some extra originator node Cⱼ such that there is an edge (Cᵢ, xⱼ) on some path in P_{C}. Since there is such an edge if and only if x₁ ∈ Cᵢ, the extra originator nodes form a solution to the set cover problem.

The foregoing description of the constrained minimum cost multicast is related to a general case of constrained minimum cost multicast. There may, however, be some special cases of constrained minimum cost multicast which may be used to determine the set of extra originator nodes (e.g., determining branching switches or other types of branching nodes in unicast branching based multicast). For example, some special cases constrained minimum cost multicast may include special cases of a constrained minimum cost valid configuration in which (1) R, which is the set of root/target nodes, is such that |R|≦k1 and/or (2) the number of multi-exit nodes X is such that |X|≦k₂ where k₁ and k₂ are constants. As demonstrated in Theorem 4, if |R|≦k₁ where k₁ is a constant, a minimum cost valid configuration can be found in polynomial time. Accordingly, it will be appreciated that instances of constrained minimum cost valid configuration in which the number source/target nodes is bounded by a constant are solvable in polynomial time (which, again, may be considered to be another theorem).

Next, as indicated above, consider a theorem (denoted as Theorem 6) which states that instances of constrained minimum cost valid configuration in which the number source/target nodes is bounded by a constant are solvable in polynomial time. A proof of this theorem follows. Call a node with degree at least 3 a branching node. The tree with the most branching nodes is a full binary tree. A full binary tree with k leaves has k−1 branching nodes. Also, suppose |R|≦k1. Consider G=(V, E) with some set O of originating nodes and let H be the corresponding graph in which we search for a Steiner tree spanning R. Let T be such a Steiner tree. Then, T has at most k₁−1 branching nodes. To have T correspond to a valid configuration, we need only have the branching nodes as extra originating nodes. Therefore, it is sufficient to try each subset of nodes of V \R of size less than k₁ as a possible set of extra originating nodes. However, if k₁ is a constant, then the entire size of H would then be a constant and, thus, the Steiner tree problem on H could be solved exactly in O(1) time for each of O(n^{k1}) subsets of V \R of size k₁ where n=|V|. Now, consider the case when |X|≦k₂. Then, for every possible subset X ⊂ V of size k₂ we have seen that we can construct an equivalent Steiner tree instance H_{X}=(X ∪ R, F_{X}). In this case, the Steiner tree problem for H_{X} can be solved approximately in polynomial time as in the general case described above. Additionally, since there are only polynomial many different choices of R, in this case constrained minimum cost valid configuration can be solved approximately in polynomial time. This is indicative of a final theorem which states that instances of constrained minimum cost valid configuration where the number of extra originator nodes in a valid configuration is bounded by a constant can be approximated within 1.39 of optimal in polynomial time.

It will be appreciated that, although primarily presented herein within the context of embodiments in which the 1.39-approx algorithm is used for the Steiner Tree Problem (where the 1.39-approx algorithm is closest to the optimal solution of the Steiner Tree Problem), in at least some embodiments other approximation algorithms (e.g., having looser bounds, such as the simple 2-approx Steiner Tree algorithm or other approximation algorithms) may be used for the Steiner Tree Problem.

It is noted that, while both of the preceding results (namely, to the Steiner tree problem presented with respect to FIGS. 4A-4B and to the Constrained Minimum Cost Configuration problem presented with respect to FIG. 5) might imply that efficient solutions to the preceding problems are intractable, it is possible to show that, in the case in which the multicast group is bounded (which is almost invariably the case), the preceding problems can be solved in polynomial time.

It is noted that the various embodiments described above for selecting the set of branching switches for a multicast group include (1) embodiments in which there are a limited number of available branching switches and any of the available branching switches may be selected as branching switches for the multicast group and (2) embodiments in which all of the switches are branching switches and only a fixed number k of the switches may be selected as branching switches for the multicast group.

In at least some embodiments, however, as discussed further below, the input is a set of candidate branching switches sets and one of the candidate branching switches sets is selected as the set of branching switches for the multicast group. Here, the set of candidate branching switches sets may be denoted as B and the candidate branching switches sets may be denoted as Bi, such that B=(B1, B2, . . . ), where each Bi represents a potential set of candidate branching switches. The candidate branching switches sets are evaluated and the candidate branching switches set Bk that results in a multicast tree having the lowest cost may be selected as the set of branching switches for the multicast group. The set of candidate branching switches selected as the set of branching switches for the multicast group may be selected by simply selecting the set of candidate branching switches to be the set of branching switches for the multicast group or by determining a configuration of the multicast tree that uses the set of candidate branching switches selected to be the set of branching switches for the multicast group (i.e., the set of candidate branching switches selected to be the set of branching switches for the multicast group is dictated by the selected configuration of the multicast tree). It is noted that, from the set of available branching switches, the candidate branching switches sets may be determined in various ways (e.g., randomly, based on policy, or the like). For example, a secure multicast group could be restricted to a set of branching switches that are capable of supporting encrypted communications, a geographically restricted multicast group could be restricted to a set of branching switches that lie within that geographical restriction. Various aspects of embodiments for selecting a set of branching switches from candidate branching switches sets are described further below.

In at least some embodiments, the input is a set of candidate branching switches sets and one of the candidate branching switches sets is selected as the set of branching switches for the multicast group. Here, the network is modeled as a graph G=(V, E) comprised of a set of switches V and a set of edges E. Here, the problem may be stated as a problem of creating a P2MP unicast branching tree with minimal “configuration cost” between a specified input ingress switch I and a specified set of output egress switches O using one set out of a specified set of candidate branching switches sets B=(B1, B2, . . . , Bn). Here, the “configuration” is defined as the set of paths used to create a unicast branching tree, where each path is a unicast unidirectional path between the ingress switch and a branching switch, between two branching switches, between a branching switch and an egress switch, or between the ingress switch and an egress switch. The “configuration” provides the information needed to install unicast forwarding state in each branching switch of the multicast tree, as well as the ingress switch and each egress switch. The “configuration cost” is defined as the edge costs associated with each edge of each path in the configuration. In particular, the cost of a path is the sum of the costs of the edges in the path and the configuration cost is the sum of the path costs in the configuration. It will be appreciated that different choices of candidate branching switches sets B=(B1, B2, . . . , Bk, . . . , Bn) will yield different configuration costs. In at least some embodiments, as noted above, the process for selecting a set of branching switches from the candidate branching switches sets is configured to select the candidate branching switches set Bk with the minimal configuration cost and output at least one of the selected candidate node set Bk or the configuration that uses the selected candidate branching switches set Bk.

In at least some embodiments, the process may be configured to use a set of inputs and produce a set of outputs. The inputs to the process may include (1) a graph G=(V, E) with edge costs as used in the underlying routing algorithms, (2) the ingress switch I and set of egress switches O for the multicast group M for which the set of branching switches is being determined (where I is an element of V and O is a subset of V), (3) the set of candidate branching switches sets B=(B1, B2, . . . Bn) where each element of B is a set of candidate branching nodes and, further, where for a given candidate branching switches set any subset of candidate branching switches of the candidate branching switches set Bk can be used in building the actual multicast tree (i.e., we do not have to use all elements of candidate branching switches set Bk in the actual multicast tree), and (4) a set of limits on the running of the process including at least one of a run time limit L1 (to limit the running time to within a specified constant) or a configuration checking limit L2 (to limit the number of configurations evaluated). The outputs of the process may include (1) the configuration of the multicast tree for input M that is built using the candidate branching switches set Bk from the set of candidate branching switches sets B that minimizes the configuration cost given the constraints L1 and L2 and (2) the configuration cost. It is noted that not all of the candidate branching switches of candidate branching switches set Bk need to be used in the multicast tree, but that no elements outside of candidate branching switches set Bk may be used as branching switches in the multicast tree. The process may include the following steps. The first step is to initialize the list of total configurations to NULL. The second step is to, for each Bi selected from the set of candidate branching switches sets B, perform the following steps while both L1 and L2 remain: (a) based on G and Bi, transform the problem into a Steiner tree problem as discussed above, (b) decide, based on L1, L2, M, G, and Bi, whether to do an exact or approximate solution of the Steiner tree problem and then determine the exact or approximate solution of the Steiner tree problem (which results in an associated configuration of the multicast tree and the corresponding configuration cost), and (c) add the configuration and corresponding configuration cost of the determined solution to the list of configurations evaluated. The third step, which is performed after the loop of the second step is complete (based on L1 and L2), includes (a) based on a determination that the total configuration list is nonempty, search the configuration list and select and return the configuration with minimum cost or (2) based on a determination that the total configuration list is empty, computing the minimum spanning tree and deleting from the multicast tree any edges that are not on a path from I to some switch of O and then return the configuration and the corresponding configuration cost.

In at least some embodiments, a process for determining a set of branching switches (where the process may or may not be provided within the context of a process for determining a multicast tree, e.g., the process may be part of a process for determining a multicast tree or the output of the process may be an input to a process for determining a multicast tree) may include receiving input information (e.g., one or more of network topology information, network topology information in the form of a graph, the ingress switch I and set of egress switches O for the multicast group M for which the set of branching switches is being determined, switch characteristics or capability information that is indicative of characteristics or capabilities of switches available for selection as branching switches, candidate branching switches or sets of candidate branching switches for evaluation, or the like, as well as various combinations thereof) and determining a set of switches to be branching switches for the multicast tree. The process may include, where candidate branching switches are provided, selecting one or more of the candidate branching switches as selected branching switches. The process may include, where sets of candidate branching switches are provided, selecting one of the sets of candidate branching switches as the selected set of branching switches (e.g., evaluating at least a portion of the sets of candidate branching switches with respect to a parameter for identifying one of the sets of candidate branching switches satisfying a threshold associated with the parameter, evaluating at least a portion of the sets of candidate branching switches with respect to a parameter for identifying one of the sets of candidate branching switches configured to optimize the parameter, or the like).

It will be appreciated that, although primarily presented with respect to embodiments in which policy-based selection of the branching switches for the multicast tree is performed within the context of determining a unicast branching based multicast tree, embodiments of policy-based selection of the branching switches for a multicast tree may be applied for determining the branching switches for various other types of multicast trees.

At block 330, the unicast branches of the multicast tree are determined. The unicast branches of the multicast tree may be determined based on the set of switches of which the multicast tree is composed (which at least includes the edge switches of the multicast tree and the branching switches of the multicast tree and which, in at least some cases, also may include other switches which may operate as pass-through switches for the multicast tree). The unicast branches of the multicast tree may be determine based on topology information of the communication network (which may include various types of information describing connectivity between various switches of the communication network). The unicast branches of the multicast tree may be determined based on various other types of information. The unicast branches of the multicast tree specify the connectivity of the multicast tree (e.g., the unicast branches connecting the various switches of which the multicast tree is composed).

At block 399, method 300 ends.

FIG. 6 depicts an embodiment of a method for establishing a unicast branching based multicast tree, for use in the method of FIG. 2. It is noted that a portion of the functions of method 600 of FIG. 6 may be executed by a central controller (e.g., CC 121 of FIG. 1) and a portion of the functions of method 600 of FIG. 6 may be executed by switches that form part of the unicast branching based multicast tree (e.g., switches 122 of FIG. 1 that form part of the unicast branching based multicast tree). It will be appreciated that, although primarily presented as being performed serially, at least a portion of the functions of method 600 may be performed contemporaneously or in a different order than as presented in FIG. 6.

At block 601, method 600 begins.

At block 610, the central controller determines configuration information for establishing the unicast branching based multicast tree. The configuration information includes configuration information for switches of the multicast tree for configuring the switches of the multicast tree.

At block 620, the central controller sends the configuration information toward the switches of the multicast tree. The respective portions of the configuration information for the respective switches of the multicast tree are sent toward the respective switches of the multicast tree.

At block 630, the switches of the multicast tree receive the configuration information from the central controller. The respective portions of the configuration information for the respective switches of the multicast tree are received by the respective switches of the multicast tree.

At block 640, the switches of the multicast tree are configured, based on the configuration information, to support the multicast tree. The respective switches of the multicast tree are configured based on the respective portions of the configuration information for the respective switches of the multicast tree. This establishes the multicast tree within the communication network.

It will be appreciated that the switches of the multicast tree for which the configuration information is determined, sent, received, and used may include all of the switches of the which the multicast tree is composed or a subset of switches of which the multicast tree is composed. The switches at least include the edge switches of the multicast tree (e.g., to provide rules and/or other state information for preserving multicast destination address information) and branching switches (e.g., to provide rules and/or other state information for controlling replication of received unicast flows into multiple downstream unicast flows).

It will be appreciated that the configuration information for configuration of the switches may be determined, sent, received, and used in various types of formats. The format of the configuration information may be based on the type of SDN implementation used within the communication network (e.g., using OpenFlow control message formats or other similar control message formats suitable for transporting configuration information for the switches of the multicast tree).

The configuration information for a switch of the multicast tree may include one or more rules (and/or other multicast state information). In general, a rule includes a set of match conditions including one or more match conditions and an associated set of actions including one or more actions to be applied when the set of match conditions is detected. For example, a rule might be [match on fields 1, 2, 3; action of change fields 2, 3, 4 and send on port 3]. It will be appreciated that the foregoing rule is merely one example of a rule for illustrating a relationship between match conditions and actions and that various other types of flow forwarding rules/packet processing rules may be supported.

The configuration information for a switch of the multicast tree may vary for switches of the multicast tree based on the roles that the switches are to play within the multicast tree (e.g., edge switches of the multicast tree or branching switches for the multicast tree), respectively.

The configuration information for an edge switch of the multicast tree may include configuration information for use in preserving the multicast destination address information of packets of the multicast tree. The configuration information may include packet processing rules for preserving the multicast destination address information of packets of the multicast tree, which may vary for multicast traffic at different layers of the communication network.

The configuration information, for an edge switch configured as an ingress point into the multicast tree (also referred to as an ingress switch of the multicast tree), may include packet processing rules (and/or other state information) for processing packets at the ingress switch to retain the multicast destination address of the multicast packets of the multicast tree. As indicated above and discussed further below, the manner in which the packets are processed at ingress switches to retain the multicast destination address of the multicast packets may vary for multicast traffic at different layers of the communication network. In at least some embodiments, for example (e.g., for Ethernet traffic, IP traffic, or the like), packet processing rules for processing of a packet at an ingress switch, in a manner for retaining the multicast destination address of the packet, may include rules configured for removing the multicast destination address from the destination address field of the packet, including the multicast destination address within the header of the packet (e.g., inserting the multicast destination address into one or more fields, encoding the multicast destination address using one or more fields, or the like), and inserting a unicast destination address of the downstream unicast branch into the destination address field from which the multicast destination address was removed. Here, the one or more fields may include one or more unused fields, one or more populated fields (e.g., by removing or overwriting the existing information of the one or more populated fields, which information may or may not need to be recovered at the egress switches), or the like, as well as various combinations thereof. In at least some embodiments, for example (e.g., for Segment Routing traffic or the like), packet processing rules for processing of a packet at an ingress switch, in a manner for retaining the multicast destination address of the packet, may include rules configured for adding one or more additional header fields configured to support unicast routing of the multicast packet via the downstream unicast branch without having to remove the multicast destination address from the destination address field of the packet. It is noted that the packet processing rules may be configured to support other methods of retaining the multicast destination address of the packet.

The configuration information, for an edge switch configured as an egress point out of the multicast tree (also referred to as an egress switch of the multicast tree), may include packet processing rules (and/or other state information) for processing packets at the egress switch to recover the multicast destination address of the multicast packets of the multicast tree. As indicated above and discussed further below, the manner in which the packets are processed at egress switches to recover the multicast destination address of the multicast packets may vary for multicast traffic at different layers of the communication network. In at least some embodiments, for example (e.g., for Ethernet traffic, IP traffic, or the like), packet processing rules for processing of a packet at an egress switch, in a manner for recovering the multicast destination address of the packet, may include rules configured for removing the unicast destination address from the destination address field of the packet, determining the multicast destination address of the packet from the header of the packet (e.g., reading the multicast destination address from one or more fields, decoding the multicast destination address from information included in one or more fields, or the like), and inserting the multicast destination address into the destination address field from which the unicast destination address was removed. Here, as indicated above with respect to processing rules applied at ingress switches, the one or more fields may include one or more unused fields, one or more populated fields (e.g., previously populated with information before being coopted for use in transporting the multicast destination address, which information may or may not need to be recovered at the egress switches), or the like, as well as various combinations thereof. In at least some embodiments, for example (e.g., for Segment Routing traffic or the like), packet processing rules for processing of a packet at an egress switch, in a manner for recovering the multicast destination address of the packet, may include rules configured for removing one or more additional header fields added to the packet to support unicast routing of the without having to determine or the multicast destination address to the destination address field of the packet (since it was not removed from the destination address field at the ingress switch). It is noted that the packet processing rules may be configured to support other methods of recovering the multicast destination address of the packet.

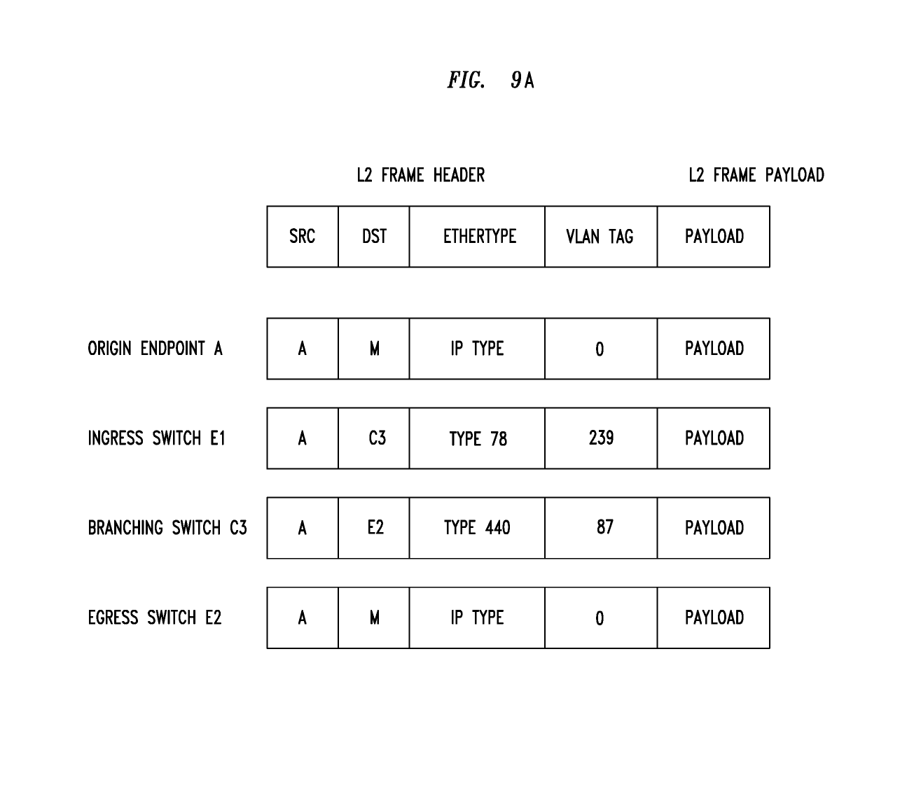

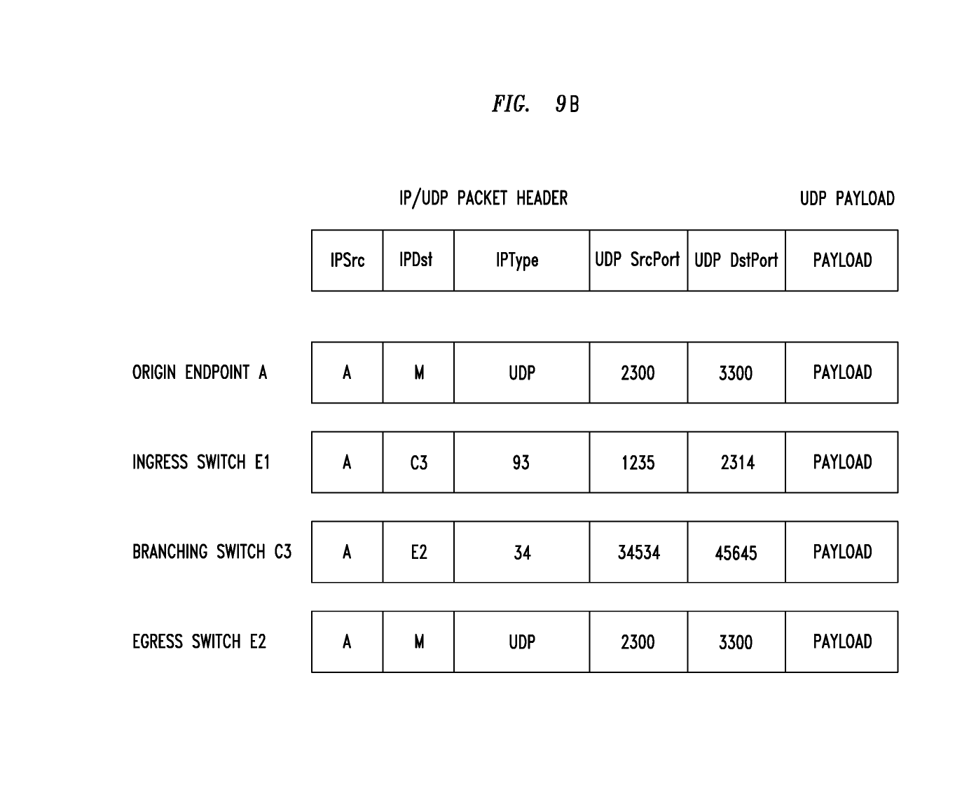

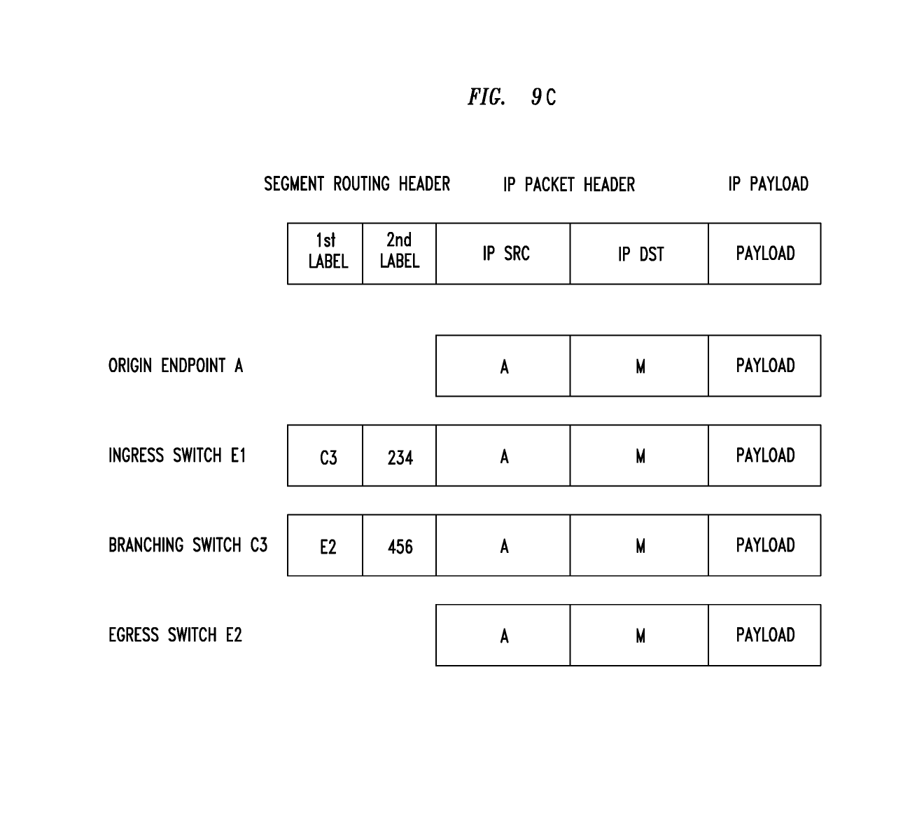

In at least some embodiments, unicast branching may be used to support multicasting in Ethernet networks (including preserving the multicast destination addresses in packets being multicast via Ethernet networks). In general, Ethernet networks are L2 networks and support the concept of L2 multicast. In at least some embodiments, the original multicast destination address is preserved at an ingress switch by encoding the original multicast destination address in the L2 header (since the higher layers typically are not examined in an L2 network). The 802.3 Ethernet header includes an Ethertype field (16 bits) and optionally includes an 802.1Q header with a VLAN tag field (12 bits). The Ethertype and VLAN tag fields, together, provide 28 bits that can be used to encode up to 2̂28 multicast groups in each branch. An example is depicted in FIG. 9A, which is based on the example of FIG. 8, which illustrates the Ethernet frame format of the L2 frames emitted at the source endpoint, the ingress (first hop) switch, a branching switch, and an egress switch. It will be appreciated that, although primarily presented with respect to embodiments in which a specific set of fields is used to preserve the multicast destination address in frames traversing unicast links of the multicast tree (namely, the Ethertype and VLAN tag fields), other fields or sets of fields (e.g., Ethertype only, VLAN tag only, Ethertype in combination with some other field, Ethertype and VLAN tag in combination with one or more other fields, or the like) may be used to preserve the multicast destination address in frames traversing unicast links of the multicast tree.

In at least some embodiments, unicast branching may be used to support multicasting in IP networks (including preserving the multicast destination addresses in packets being multicast via IP networks). It is noted that, while IP unicast traffic is transported using a variety of upper layer protocols (e.g., Transmission Control Protocol (TCP), User Datagram Protocol (UDP), Stream Control Transmission Protocol (SCTP), or the like), IP multicast is typically only done with UDP traffic. As a result, without loss of generality, it is assumed that the IP network carries UDP encoded multicast traffic. Accordingly, in at least some embodiments, the original multicast destination address may be preserved by reusing a combination of UDP fields and IP fields. The UDP header includes source and destination port fields (16 bits each) which may be reused and the IP header includes an IP Type field (8 bits). The UDP source and destination port fields and the IP Type field, together, provide 40 bits that can be used to encode up to 2̂40 multicast groups in each branch. This is depicted in FIG. 9B, which is based on the example of FIG. 8, which illustrates the IP/UDP packet format of the IP/UDP packets emitted at the source endpoint, the ingress (first hop) switch, a branching switch, and an egress switch. It is noted that, where one or more populated fields are used by ingress switches for retaining the multicast destination address (e.g., the UDP source and destination port fields), the associated egress switches also may be configured to restore the original information included in the one or more populated fields (e.g., the original UDP source and destination ports included in the original packet received by the ingress switch). It will be appreciated that, although primarily presented with respect to embodiments in which a specific set of fields is used to preserve the multicast destination address in frames traversing unicast links of the multicast tree (namely, the UDP source and destination port fields and the IP Type field), other fields or sets of fields (e.g., UDP source and destination port fields only, the IP Type field only, IP Type field in combination with some other field, UDP source and destination port fields and the IP Type field in combination with one or more other fields, or the like) may be used to preserve the multicast destination address in frames traversing unicast links of the multicast tree.

In at least some embodiments, unicast branching may be used to support multicasting in Segment Routing networks (including preserving the multicast destination addresses in packets being multicast via Segment Routing networks). In general, Segment Routing is an evolution of Multiprotocol Label Switching (MPLS) networks in which a label can either encode a globally known destination (nodal segment) or a locally known destination (adjacency segment). In either case, the destination is a unicast destination. It is possible to stack labels, with each label representing an intermediate destination in the sequence. In at least some embodiments, for unicast branching, each unicast branch is encoded by a stack of two labels. The first label encodes the nodal segment of the branch destination and serves to route the packet to the nodal segment of the branch destination. The second label encodes an adjacency segment that acts as an index into the rules table at the branch destination. Since each segment label (as with an MPLS label) has a 20-bit value, it is possible to encode 2̂20 multicast groups with a single adjacency segment or to encode 2̂40 multicast groups with two adjacency segments. This is depicted in FIG. 9C, which is based on the example of FIG. 8, which illustrates the segment label pairs added to the packet at the ingress switch and a branching switch and, further illustrates removal of the segment labels by the egress switch. It is noted that use of unicast branching to support multicasting in segment routing networks is configured such that the original packet that is received does not need to be modified and, thus, the egress switch does not need to support any special steps to recover the multicast destination address. It is further noted that, while use of unicast branching to support multicasting in segment routing networks adds a header to the packet such that the MTU of the packet changes, the change does not matter since segment routing networks typically use an internal MTU that is larger than the MTU that is used outside of the segment routing network (e.g., in the associated access network) so that packets which are of MTU size outside of the segment routing network can be transported across the segment routing network without the need for fragmentation.

The configuration information for a branching switch of the multicast tree may include configuration information for use supporting a unicast-based branching point of the multicast tree. It is noted that edge switches operating as ingress switches of the multicast tree also may be configured to operate as branching switches of the multicast tree (depending on where the branching is to occur within the multicast tree).

The configuration information for a branching switch of the multicast tree may include configuration information for use in replicating packets of the multicast tree and for use in supporting unicast-based transport of the packets of the multicast tree.

The configuration information for use in replicating packets of the multicast tree may include packet processing rules for replicating packets of the multicast tree that are received at an ingress interface of the switch to replicate the packets across multiple egress interfaces of the branching switch.

The configuration information for use in replicating packets of the multicast tree may include configuration information for configuring a rules table to support replication of packets of the multicast tree (e.g., replication of packets received via a single ingress interface for distribution of the packets across multiple egress interfaces of the branching switch). For example, for a switch having ingress interface I1 and egress interfaces E1, E2, E3, and E4, a packet processing rule for a particular multicast group may indicate that packets of the multicast group received via ingress interface I1 are to be replicated and sent over egress interfaces E2 and E3.

The configuration information for use in replicating packets of the multicast tree may include configuration information for configuring a group table (e.g., OpenFlow Group Table or other suitable type of group table) to support replication of packets of the multicast tree (e.g., replication of packets received via a single ingress interface for distribution of the packets across multiple egress interfaces of the branching switch). The group table may be configured such that, for each of the output interfaces over which the incoming packet is to be replicated, the group table includes a respective rule including the match condition for the incoming packet and the respective action for replicating the incoming packet and sending the replicated packet over the respective output interface. For example, in order to match an incoming packet on fields 1, 2, 3, replicate the packet for transmission via port 3 (while also transforming fields 2 and 5) and port 7 (while also transforming fields 2, 3, and 6), the group table might include (1) a first rule having a match condition of [match on fields 1, 2, 3] and an action of [change fields 2 and 5, and send on port 3] and (2) a second rule having a match condition of [match on fields 1, 2, 3] and an action of [change fields 2, 3, and 6, and send on port 7].

The configuration information for use in replicating packets of the multicast tree may include configuration information for configuring a flow table (e.g., OpenFlow Flow Table or other suitable type of flow table) to support replication of packets of the multicast tree (e.g., replication of packets received via a single ingress interface for distribution of the packets across multiple egress interfaces of the branching switch). The flow table may be configured such that, for each of the output interfaces over which the incoming packet is to be replicated, the group table includes a single rule including the match condition for the incoming packet and multiple associated actions for replicating the incoming packet and sending the replicated packet over the respective output interfaces. For example, in order to match an incoming packet on fields 1, 2, 3, replicate the packet for transmission via port 3 (while also transforming fields 2 and 5) and port 7 (while also transforming fields 2, 3, and 6), the flow table might include a rule having a match condition of [match on fields 1, 2, 3] and two associated actions of (1) [change fields 2 and 5, and send on port 3] and (2) [change fields 2, 3, and 6, and send on port 7].

It is noted that an advantage of using a group table over a flow table for supporting replication of packets is that the group table supports parallel processing across the different output interfaces over which the incoming packet is to be replicated, while the flow table supports sequential processing across the different output interfaces over which the incoming packet is to be replicated.

The configuration information for use in supporting unicast-based transport of the packets of the multicast tree may include packet processing rules for updating the unicast destination address information of packets. The configuration information for use in supporting unicast-based transport of the packets of the multicast tree may include configuration information for configuring a flow table (e.g., OpenFlow Flow Table or other suitable type of flow table) or a group table (e.g., OpenFlow Group Table or other suitable type of group table) to support rewriting of unicast destination address information in the packets. For example, for a switch having ingress interface I1 and egress interfaces E1 (connected to switch S1 having unicast address UA1), E2 (connected to switch S2 having unicast address UA2), E3 (connected to switch S3 having unicast address UA3), and E4 (connected to switch S4 having unicast address UA4), a packet processing rule for a particular multicast group may indicate that packets of the multicast group received via ingress interface I1 are to be replicated and sent over egress interface E2 to switch S2 (by removing the unicast address of the switch from the destination address field and inserting the unicast address UA2 of switch S2 into the destination address field) and over egress interface E3 to switch S3 (by removing the unicast address of the switch from the destination address field and inserting the unicast address UA3 of switch S3 into the destination address field).

The configuration information for use in replicating packets of the multicast tree may include packet processing rules for providing various other functions related to replication of packets of a multicast group for transport via unicast-based communications.

The configuration information for a switch of the multicast tree may include various other rules, multicast state information, table entries, or the like, as well as various combinations thereof.

At block 699, method 600 ends.

FIG. 7 depicts an embodiment of a method for use by a switch for forwarding packets within a unicast branching based multicast tree. It is noted that method 700 of FIG. 3 may be executed by switches that form part of the unicast branching based multicast tree (e.g., switches 122 of FIG. 1 that form part of the unicast branching based multicast tree). It will be appreciated that, although primarily presented as being performed serially, at least a portion of the functions of method 700 may be performed contemporaneously or in a different order than as presented in FIG. 7.

At block 701, method 700 begins.

At block 710, the switch receives a packet of a multicast group. The packet, depending on the location and role of the receiving switch within the multicast tree (e.g., ingress switch, ingress switch and branching switch, branching switch, egress switch, or the like), may be an original multicast packet or a modified packet (modified to support unicast-based transport of the original multicast packet via a multicast tree that is composed of unicast branches).

At block 720, the switch processes the packet of the multicast group to form thereby a modified packet for the multicast group. The processing of the packet to form the modified packet, as noted above with respect to block 710 and discussed in additional detail with respect to the method of FIG. 6 and the example of FIG. 8, may include various types of processing (e.g., preservation of the multicast destination address at an ingress switch, replication of the packet at a branching switch, rewriting of unicast destination address information at any switch, recovery of the multicast destination address at an egress switch, or the like, as well as various combinations thereof.

At block 730, the switch transmits the modified packet for the multicast group. The modified packet for the multicast group is transmitted downstream for delivery to one or more multicast destinations.

At block 799, method 700 ends.

FIG. 8 depicts an example unicast branching based multicast tree for a multicast group.

The unicast branching based multicast tree 800 is a P2MP tree for a multicast group M (where M is used as the multicast destination address of the multicast group).

The unicast branching based multicast tree 800 is rooted at a source endpoint device A and includes four destination endpoint devices B, C, D, and E. The unicast branching based multicast tree 800 includes three edge switches (denoted as E1, E2, and E3). The unicast branching based multicast tree 800 includes five intermediate (or core) switches (denoted as C1, C2, C3, C4, and C5). The edge switch E1, intermediate switch C1, intermediate switch C2, intermediate switch C4, and intermediate switch C5 are non-branching switches. The intermediate switch C3 (assigned a unicast destination address of “x”), edge switch E2 (assigned a unicast destination address of “y”), and edge switch E3 (assigned a unicast destination address of “z”) are branching switches. The unicast branching based multicast tree 800 includes various communication links connecting the various switches to form the unicast branching based multicast tree 800: a link between A and E1, a link between E1 and C1, a link between C1 and C2, a link between C2 and C3 (denoted as link c), a link between C3 and C4 (denoted as link a), a link between C3 and C5 (denoted as link b), a link between C4 and E2, a link between C5 and E3, a link between E2 and B, a link between E2 and C, a link between E3 and D, and a link between E3 and E.

The unicast branching based multicast tree 800 is supported using configuration information installed at various switches.

The edge switch E1, which is not a branching switch for the multicast tree, includes a Flow Table entry that includes (1) a matching condition of {A, M} and (2) a corresponding action of {A, C3, x, link C1}, which indicates that the multicast destination address M of the packet is to be replaced with the unicast destination address C3 (identifying intermediate switch C3), that the multicast destination address of the packet is to be encoded within the packet (represented as “x”), and that the modified packet is to be sent over link C1 which connects edge switch E1 to intermediate switch C1 (the first hop on the path toward intermediate switch C3).

The intermediate switch C3, which is a branching switch for the multicast tree, includes a Group Table entry that includes (1) a matching condition of {A, C3, x} and two corresponding actions of which indicate that the received unicast packet is to be replicated so as to provide two modified unicast packets, where the two corresponding actions include (2a) a first action {A, E2, y, link a}, which indicates that the unicast destination address C3 of the packet is to be replaced with the unicast destination address E2 (identifying edge switch E2), that the encoding of the multicast destination address within the packet is to be modified (replacing “x” with “y”), and that the modified packet is to be sent over link a which connects intermediate switch C3 to intermediate switch C4 (the first hop on the path toward edge switch E2) and (2b) a second action {A, E3, z, link b}, which indicates that the unicast destination address C3 of the packet is to be replaced with the unicast destination address E3 (identifying edge switch E3), that the encoding of the multicast destination address within the packet is to be modified (replacing “x” with “z”), and that the modified packet is to be sent over link a which connects intermediate switch C3 to intermediate switch C5 (the first hop on the path toward edge switch E3).

The edge switch E2, which is a branching switch for the multicast tree, includes a Group Table entry that includes (1) a matching condition of {A, E2, y} and two corresponding actions of which indicate that the received unicast packet is to be replicated so as to provide two restored multicast packets, where the two corresponding actions include (2a) a first action {A, M, link B}, which indicates that multicast destination address M is to be recovered from the encoding “y” of the multicast destination address M within the packet, that the encoding “y” of the multicast destination address M within the packet is to be removed from the packet, that the unicast destination address E2 of the packet is to be replaced with the multicast destination address M of the multicast group, and that the modified packet is to be sent over link B which connects edge switch E2 to endpoint device B and (2b) a second action {A, M, link C}, which indicates that multicast destination address M is to be recovered from the encoding “y” of the multicast destination address M within the packet, that the encoding “y” of the multicast destination address M within the packet is to be removed from the packet, that the unicast destination address E2 of the packet is to be replaced with the multicast destination address M of the multicast group, and that the modified packet is to be sent over link C which connects edge switch E2 to endpoint device C.

The edge switch E3, which is a branching switch for the multicast tree, includes a Group Table entry that includes (1) a matching condition of {A, E3, z} and two corresponding actions of which indicate that the received unicast packet is to be replicated so as to provide two restored multicast packets, where the two corresponding actions include (2a) a first action {A, M, link D}, which indicates that multicast destination address M is to be recovered from the encoding “z” of the multicast destination address M within the packet, that the encoding “z” of the multicast destination address M within the packet is to be removed from the packet, that the unicast destination address E3 of the packet is to be replaced with the multicast destination address M of the multicast group, and that the modified packet is to be sent over link D which connects edge switch E3 to endpoint device D and (2b) a second action {A, M, link E}, which indicates that multicast destination address M is to be recovered from the encoding “z” of the multicast destination address M within the packet, that the encoding “z” of the multicast destination address M within the packet is to be removed from the packet, that the unicast destination address E3 of the packet is to be replaced with the multicast destination address M of the multicast group, and that the modified packet is to be sent over link E which connects edge switch E3 to endpoint device E.

It will be appreciated that, although the various rules and state information of the switches of the multicast tree 800 are primarily presented as being arranged in a particular arrangement, the various rules and state information of the switches of the multicast tree 800 may be organized in other ways.

The unicast branching based multicast tree 800 illustrates the unicast-based routing of a multicast packet [A, M] from source endpoint device A to each of the destination endpoint devices B, C, D, and E.

The source endpoint device A sends the multicast packet [A, M] to the ingress switch of the multicast tree for the multicast group (switch E1). In the multicast packet [A, M], A is the source multicast address in the source address field and M is the multicast destination address in the destination address field.

The ingress switch E1 receives the multicast packet [A, M] from source endpoint device A and processes the multicast packet [A, M], based on the flow table entry for the multicast group, to form a modified packet [A, C3, x]. In the modified packet [A, C3, x], the A is the source multicast address in the source address field, C3 is the unicast destination address (replacing multicast destination address M) in the destination address field, and x is the encoding of the multicast destination address M within the packet. The modified packet [A, C3, x] is routed from edge switch E1 to intermediate switch C3, via the intermediate switch 01 and the intermediate switch C2, based on the unicast destination address C3.

The intermediate switch C3 receives the unicast packet [A, C3, x] and processes the unicast packet [A, C3, x], based on the group table entry for the multicast group, to form a first modified packet [A, E2, y] and a second modified packet [A, E3, z] (i.e., the unicast packet [A, C3, x] is replicated, because intermediate switch C3 is a branching switch of the multicast tree). In the first modified packet [A, E2, y], A is the source multicast address in the source address field, E2 is the unicast destination address (replacing previous unicast destination address C3) in the destination address field, and y is the encoding of the multicast destination address M within the packet (replacing previous encoding “x”). The first modified packet [A, E2, y] is routed from intermediate switch C3 to edge switch E2, via the intermediate switch C4, based on the unicast destination address E2. In the second modified packet [A, E3, z], A is the source multicast address in the source address field, E3 is the unicast destination address (replacing previous unicast destination address C3) in the destination address field, and z is the encoding of the multicast destination address M within the packet (replacing previous encoding “x”). The second modified packet [A, E3, z] is routed from intermediate switch C3 to edge switch E3, via the intermediate switch C5, based on the unicast destination address E3.

The edge switch E2 receives the unicast packet [A, E2, y] and processes the unicast packet [A, E2, y], based on the group table entry for the multicast group, to form a first recovered multicast packet [A, M] and a second recovered multicast packet [A, M] (i.e., the recovered multicast packet [A, M] is replicated, because edge switch E2 is a branching switch of the multicast tree). The first and second recovered multicast packets may be formed by recovering the multicast packet [A, M] from the unicast packet [A, E2, y] and replicating the recovered multicast packet [A, M] (or vice versa). In each recovered multicast packet, A is the source multicast address in the source address field and M is the multicast destination address in the destination address field (replacing the unicast destination address E2 in the destination address field of the received unicast packet). The multicast destination address is recovered at edge switch E2 based on the encoding of the multicast destination address M within the received unicast packet (illustratively, “y”). The first recovered multicast packet [A, M] is routed from edge switch E2 to endpoint device B based on the first action of the group table entry and the second recovered multicast packet [A, M] is routed from edge switch E2 to endpoint device C based on the second action of the group table entry.

The edge switch E3 receives the unicast packet [A, E3, z] and processes the unicast packet [A, E3, z], based on the group table entry for the multicast group, to form a first recovered multicast packet [A, M] and a second recovered multicast packet [A, M] (i.e., the recovered multicast packet [A, M] is replicated, because edge switch E3 is a branching switch of the multicast tree). The first and second recovered multicast packets may be formed by recovering the multicast packet [A, M] from the unicast packet [A, E3, z] and replicating the recovered multicast packet [A, M] (or vice versa). In each recovered multicast packet, A is the source multicast address in the source address field and M is the multicast destination address in the destination address field (replacing the unicast destination address E3 in the destination address field of the received unicast packet). The multicast destination address is recovered at edge switch E3 based on the encoding of the multicast destination address M within the received unicast packet (illustratively, “z”). The first recovered multicast packet [A, M] is routed from edge switch E3 to endpoint device D based on the first action of the group table entry and the second recovered multicast packet [A, M] is routed from edge switch E3 to endpoint device E based on the second action of the group table entry.

It will be appreciated that the configuration and operation of multicast tree 800 of FIG. 8 may be further understood by way of reference to FIGS. 1-7, as well as by way of reference to FIGS. 9A-9C which, as discussed further below, depict example packet formats for packets forwarded via the unicast branching based multicast tree 800 of FIG. 8.

It will be appreciated, from the above description of the configuration and operation of multicast tree 800 of FIG. 8, that use of unicast branching based multicast may obviate the need for multicast state information to be installed on all switches of the multicast tree (rather, only the ingress and egress switches and the branching switches have multicast state information stored thereon).

FIGS. 9A-9C depict example packet formats for packets forwarded via the unicast branching based multicast tree of FIG. 8.

FIG. 9A depicts the contents of an Ethernet frame, where the multicast tree 800 of FIG. 8 is used for L2 Ethernet unicast branching, at different points of the multicast tree 800 as the Ethernet frame traverses the multicast tree 800. The Ethernet frame in this example is sourced by source endpoint device A (referred to as origin endpoint A) and traverses a path of the multicast tree 800 that includes edge switch E1 (denoted as ingress switch E1), intermediate switch C3 (denoted as branching switch C3), and edge switch E2 (denoted as egress switch E2). The Ethernet frame includes an L2 Frame Header and an L2 Frame Payload. The L2 Frame Header includes a source address field (Src), a destination address field (Dst), an Ethernet type field (Ethertype), and a VLAN tag field (VLAN tag). The Ethernet frame that is sent by origin endpoint A is a multicast frame that has an L2 Frame Header of [A, M, IP Type, 0], where M denotes the multicast destination address of the multicast group. The Ethernet frame that is sent by ingress switch E1 is a unicast frame that has an L2 Frame Header of [A, C3, Type 78, 239], where unicast destination address C3 has replaced multicast destination address M in the destination address field and the multicast destination address M has been encoded (preserved) in the unicast Ethernet frame using a combination of [Type 78, 239] in the Ethertype and VLAN tag fields. The Ethernet frame that is sent by branching switch C3 is a unicast frame that has an L2 Frame Header of [A, E2, Type 440, 87], where unicast destination address E2 has replaced unicast destination address C3 in the destination address field and the multicast destination address M has be encoded (preserved) in the unicast Ethernet frame using a combination of [Type 440, 87] in the Ethertype and VLAN tag fields. The Ethernet frame that is sent by egress switch E2 is a restored multicast frame that has an L2 Frame Header of [A, M, IP Type, 0], which is the original L2 Frame Header of the Ethernet frame sourced by origin endpoint A. Here, the combination of [Type 440, 87] in the Ethertype and VLAN tag fields of the Ethernet frame received by egress switch E2 is used to recover the multicast destination address M, which is then inserted back into the destination address field such that the Ethernet frame received by the destination endpoint includes the multicast destination address M of the multicast group with which the Ethernet frame is associated.

FIG. 9B depicts the contents of an IP packet, where the multicast tree 800 of FIG. 8 is used for L3 IP unicast branching, at different points of the multicast tree 800 as the IP packet traverses the multicast tree 800. The IP packet in this example is sourced by source endpoint device A (referred to as origin endpoint A) and is transported using UDP. The IP packet in this example traverses a path of the multicast tree 800 that includes edge switch E1 (denoted as ingress switch E1), intermediate switch C3 (denoted as branching switch C3), and edge switch E2 (denoted as egress switch E2). The IP packet includes an IP/UDP Packet Header and a UDP Payload. The IP/UDP Packet Header includes a IP source address field (IPSrc), an IP destination address field (IPDst), an IP Type field (IPtype), a UDP Source Port field (UDPSrcPort), and a UDP Destination Port field (UDPDstPort). The IP packet that is sent by origin endpoint A is a multicast packet that has an IP/UDP Packet Header of [A, M, UDP, 2300, 3300], where M denotes the multicast destination address of the multicast group. The IP packet that is sent by ingress switch E1 is a unicast frame that has an IP/UDP Packet Header of [A, C3, 93, 1235, 2314], where unicast destination address C3 has replaced multicast destination address M in the destination address field and the multicast destination address M has been encoded (preserved) in the unicast IP packet using a combination of [93, 1235, 2314] in the IPType, UDPSrcPort, and UDPDstPort fields. The IP packet that is sent by branching switch C3 is a unicast packet that has an IP/UDP Packet Header of [A, E2, 34, 34534, 45645], where unicast destination address E2 has replaced unicast destination address C3 in the destination address field and the multicast destination address M has be encoded (preserved) in the unicast IP packet using a combination of [34, 34534, 45645] in the IPType, UDPSrcPort, and UDPDstPort fields. The IP packet that is sent by egress switch E2 is a restored multicast packet that has an IP/UDP Packet Header of [A, M, UDP, 2300, 3300], which is the original IP/UDP Packet Header of the IP packet sourced by origin endpoint A. Here, the combination of [34, 34534, 45645] in the IPType, UDPSrcPort, and UDPDstPort fields of the IP packet received by egress switch E2 is used to recover the multicast destination address M, which is then inserted back into the destination address field such that the IP packet received by the destination endpoint includes the multicast destination address M of the multicast group with which the IP packet is associated.

FIG. 9C depicts the contents of an IP packet transported as a Segment Routing packet, where the multicast tree 800 of FIG. 8 is used for Segment Routing unicast branching, at different points of the multicast tree 800 as the IP packet traverses the multicast tree 800. The IP packet in this example is sourced by source endpoint device A (referred to as origin endpoint A). The IP packet in this example traverses a path of the multicast tree 800 that includes edge switch E1 (denoted as ingress switch E1), intermediate switch C3 (denoted as branching switch C3), and edge switch E2 (denoted as egress switch E2). The IP packet includes an IP Packet Header and an IP Payload. The IP Packet Header includes an IP source address field (IPSrc) and an IP destination address field (IPDst). The IP packet is transported as a Segment Routing packet based on encapsulation of the IP packet using a pair of labels referred to as a First Label (the outer label) and a Second Label (the inner label). The IP packet that is sent by origin endpoint A is a multicast packet that has an IP Packet Header of [A, M], where M denotes the multicast destination address of the multicast group. The ingress switch E1 encapsulates the IP packet using a Segment Routing Header of [C3, 234], where unicast destination address C3 is a nodal label that enables unicast routing of the IP packet via the multicast tree 800 to branching switch C3 and 234 is an adjacency label only significant at branching switch C3 which indicates the encoded multicast group and the relevant packet transformations for that multicast group. The branching switch C3 removes the Segment Routing Header of [C3, 234] and encapsulates the IP packet using a Segment Routing Header of [E2, 456], where unicast destination address E2 is a nodal label that enables unicast routing of the IP packet via the multicast tree 800 to egress switch E2 and 456 is an adjacency label only significant at egress switch E2 which indicates the encoded multicast group and the relevant packet transformations for that multicast group. It is noted that, for unicast branching based multicast in Segment Routing networks, the multicast destination address M is still preserved in the IP packet by encapsulating the IP packet without modifying the contents of the IP packet. The egress switch E2 decapsulates the IP packet by removing the Segment Routing Header of [E2, 456] from the IP packet to recover thereby the original IP packet sourced by origin endpoint A.

Various embodiments of unicast branching based multicast, as discussed above, support various functions at various switches of which the multicast tree is composed. For example, when an incoming multicast packet is received at the head of the multicast tree (ingress switch), the ingress switch at the head of the multicast tree transforms this standard multicast packet into one or more unicast packets that flow out on each branch of the multicast tree associated with the head of the multicast tree. The transformation is as per the forwarding state installed on the switch (e.g., by the SDN controller) and involves replacing the multicast destination address of the incoming multicast packet with the unicast destination address(es) of the tail(s) of the branch(es) while also preserving (e.g., encoding or maintaining) the multicast destination address within the packet. When an incoming packet is received at a branching point of the multicast tree (branching switch), the branching switch transforms this packet into one or more unicast packets that flow out on each branch of the multicast tree associated with the branching point of the multicast tree. The transformation is as per the forwarding state installed on the switch (e.g., by the SDN controller) and involves replacing the destination address of the incoming packet (e.g., a multicast destination address where the branching switch is the ingress switch for the multicast tree or a unicast destination address where the branching switch is not the ingress switch for the multicast tree) with the unicast destination address(es) of the tail(s) of the branch(es) while also preserving (e.g., encoding or maintaining) the multicast destination address within the packet. This process may continue branch-by-branch until the unicast packet in the last branch arrives at an egress switch which transforms the unicast packet into the original multicast packet based on rules installed at the egress switch (e.g., by the SDN controller) and forwards the recovered multicast packet to the multicast recipient. Various embodiments of unicast branching based multicast support packet transformations at each branch of the multicast tree (e.g., replacement at the head of each branch of the multicast tree of the incoming destination address with the destination address of the tail of the branch, encoding the multicast destination address information within the packet on a branch-by-branch basis until the leaf switches use the encoded information to recover the multicast destination address information, or the like, as well as various combinations thereof). Various embodiments of unicast branching based multicast may support various other functions which may be performed at various switches of the multicast tree.

It will be appreciated that, although various embodiments of unicast branching based multicast are primarily presented within the context of particular communication network layers (e.g., Ethernet at L2, Segment Routing at L2.5, IP at L3, and the like), various embodiments of unicast branching based multicast also may be used at other communication network layers. In at least some embodiments, for example, unicast branching based multicast may be used to support multicasting in content control networks such as content caching networks (CCNs), content streaming networks (CSNs), content distribution networks (CDNs), or the like. There exist a large number of content control networks which push web data at large geographic scales by operating their own global overlay networks. While these content control networks are able to serve static and dynamic data, they are typically unable to stream data via multicast since there is typically no multicast support by Internet Service Providers (ISPs) for third parties. These content control networks can, however, use their globally distributed caches/points-of-presence (PoPs) to create a global unicast branching based multicast tree for each streaming event. This removes the need to launch a unicast stream from the original source for each viewer. It is noted that, while new web streaming standards like webRTC support UDP based streaming, the traditional web streaming model is based on HTTP streaming over TCP and, thus, is not amenable for multicasting since TCP cannot be multicast. In at least some embodiments, this problem may be overcome by creating, at each cache/PoP, a stream sink that acts as the stream source for downstream branches. Since the sources and sinks on each branch are standard TCP based web endpoints, it is relatively easy to create the appropriate rules in the switches associated with the caches/PoPs (e.g., using off-the-shelf software-based OpenFlow switches or other suitable switches). It will be appreciated that embodiments of unicast branching based multicast may be used to support multicasting at various other communication network layers.

It will be appreciated that, although various embodiments of unicast branching based multicast are primarily presented within the context of a particular type of multicasting (namely, P2MP multicasting), various embodiments of unicast branching based multicast also may be provided for other types of multicasting (e.g., MP2P, MP2MP, or the like). In at least some embodiments, unicast branching may be configured to provide efficient support for MP2MP groups. It is noted that, while one way of supporting MP2MP groups is to create a separate P2MP group for each sender, this is quite inefficient if each sender only sends data intermittently. For example, many applications create a broadcast bus for each application instance to broadcast configuration changes of interest to the entire group; however, it is inefficient to create a separate multicast tree rooted at each application instance for this purpose. Accordingly, in at least some embodiments, rather than creating a separate P2MP group for each sender, a common multicast tree is created for the entire multicast group. In this case, referring again to the example above, whenever an application instance sends a multicast message to the multicast group, this message is transformed into a unicast message at the ingress switch and sent to the root of the tree, which then injects the message into the tree using unicast branching. It is noted that, since unicast branching does not modify the source address, when the multicast packet exits the egress switch at the leaf of the multicast tree, the multicast packet will recover the original multicast destination address and will still have the original unicast source address identifying the original sender. This is depicted in FIG. 7, which illustrates the same multicast group M as in FIGS. 2 and 3, but with the addition of endpoint E as an additional sender. In this case, the ingress switch E3 transforms the incoming multicast packet <E, M> into <E, C3, x>, where C3 is the unicast address of the tree head end, and x is the encoding of the multicast group in the other packet header fields. As a result, the multicast packets from both A and E are unicast to C3, where they share a common tree to each recipient. Since the source address is unchanged, the egress switch is able to send the original packets from both A and E to all multicast recipients.

It will be appreciated that, although primarily presented herein within the context of using embodiments of the multicast communication support capabilities to support static multicast (in which the members of the multicast group are fixed a priori), embodiments of the multicast communication support capabilities also may be used to support dynamic multicast (in which the members of the multicast group may join and leave the multicast group dynamically, e.g., using multicast group membership management protocols such as IGMP or the like). In at least some embodiments of dynamic multicast, the multicast tree may have an initial configuration determined based on policy-based multicast (and including an initial set of branching switches) and, based on a determination that the multicast tree has changed by a sufficient amount (e.g., has become sufficiently unbalanced from the optimal configuration due to dynamics of the multicast tree, such addition of new recipients, removal of existing recipients, or the like), a new configuration of the multicast tree is determined based on policy-based multicast (thereby resulting in a new set of branching switches) and the multicast tree is migrated from the initial configuration to the new configuration. It will be appreciated that, given that the multicast tree includes unicast branches, the migration may include moving the unicast branches, branch by branch, such that the tree changes from the initial configuration to the new configuration.

Various embodiments of multicast communication support capabilities, including unicast branching based multicast capabilities and policy-based multicast capabilities, may provide various advantages or potential advantages. For example, various embodiments of unicast branching based multicast may obviate the need for multicast state information to be installed on all switches of the multicast tree (rather, only the ingress and egress switches and the branching switches have multicast state information stored thereon). For example, various embodiments of unicast branching based multicast obviate the need for multicast visibility inside of the communication network (since unicast branches are used) and, thus, that the multicast tree may be established and operated based on unicast technology. For example, various embodiments of unicast branching based multicast enable multicast to be extended to Segment Routing networks. It is noted that segment routing brings a couple of key advantages to unicast routing and that these advantages are carried over to unicast branching as well: (1) it is possible to create policy-driven unicast paths, without the need to install state in each forwarding element along the path, by chaining the nodal segments/labels corresponding to the hops in the path at the origin, thereby enabling use of policies not only to select the branching switches and to select the path of each branch and, thus, enabling service chained multicast without any extra forwarding state and (2) the global knowledge of nodal segments means that, if any hop along a path to a nodal segment were to fail, it would be possible for the previous hop to reroute the packets along this path automatically to an alternate path and, thus, the fast reroute feature of mission critical networks may be built into Segment Routing. In other words, since unicast branching works with Segment Routing, not only does unicast branching enable multicasting in Segment Routing networks, but also the policy driven service chaining and fast reroute features of Segment Routing are made available for multicast. For example, various embodiments of the multicast communication support capabilities may enable multicast to be introduced into non-multicast-enabled networks in a controlled manner. For example, various embodiments of the multicast communication support capabilities may enable multicast-enabled networks that are not currently SDN-enabled to be transitioned to SDN-enabled networks without the need to install multicast state in each switch (or to be transitioned to other similar types of software-based networking). For example, various embodiments of the multicast communication support capabilities may support various types of multicasting (e.g., P2MP, MP2P, MP2MP, or the like). For example, various embodiments of policy-based multicast enable service chained functions to be added to multicasting in an efficient manner. Various embodiments of the multicast communication support capabilities may provide various other advantages or potential advantages.

It will be appreciated that, although primarily presented herein with respect to embodiments in which policy-based multicast is used to select the branching switches for a multicast tree formed and operated using unicast based branching, policy-based multicast may be used to select the branching switches for a multicast tree formed and/or operated in other ways (i.e., not based on unicast based branching). Accordingly, it will be appreciated that, in at least some embodiments, unicast based branching and policy-based multicast may be used independently of each other.

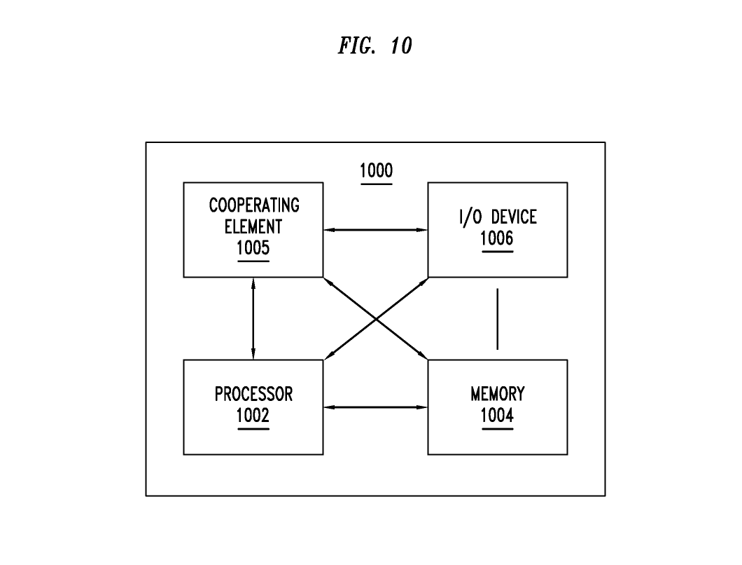

FIG. 10 depicts a high-level block diagram of a computer suitable for use in performing various functions presented herein.

The computer 1000 includes a processor 1002 (e.g., a central processing unit (CPU), a processor having a set of processor cores, a processor core of a processor, or the like) and a memory 1004 (e.g., a random access memory (RAM), a read only memory (ROM), or the like). The processor 1002 and the memory 1004 are communicatively connected.

The computer 1000 also may include a cooperating element 1005. The cooperating element 1005 may be a hardware device. The cooperating element 1005 may be a process that can be loaded into the memory 1004 and executed by the processor 1002 to implement functions as discussed herein (in which case, for example, the cooperating element 1005 (including associated data structures) can be stored on a non-transitory computer-readable storage medium, such as a storage device or other storage element (e.g., a magnetic drive, an optical drive, or the like)).

The computer 1000 also may include one or more input/output devices 806. The input/output devices 1006 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 1000 of FIG. 10 may represent a general architecture and functionality suitable for implementing functional elements described herein, portions of functional elements described herein, or the like, as well as various combinations thereof. For example, computer 1000 may provide a general architecture and functionality that is suitable for implementing all or part of one or more of an ED 110, CC 121, a switch 122, or the like.

It will be appreciated that at least some of the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive, at a first switch of a multicast tree of a multicast group, a multicast packet comprising a header and a payload, the header comprising a destination address field including a multicast destination address of the multicast group;
modify the multicast packet at the first switch of the multicast tree, to form thereby a modified packet, by updating the destination address field of the header to include a unicast destination address of a second switch of the multicast tree and adding the multicast destination address of the multicast group to the header; and
send the modified packet toward the second switch of the multicast tree.

2. The apparatus of claim 1, wherein the processor is configured to add the multicast destination address of the multicast group to the header of the packet by encoding the multicast destination address of the multicast group within one or more header fields of the header.

3. The apparatus of claim 1, wherein the multicast packet comprises an Ethernet frame, wherein the processor is configured to add the multicast destination address of the multicast group to the header of the packet using at least one of an Ethertype field of the Ethernet frame or a virtual local area network (VLAN) Tag field of the Ethernet frame.

4. The apparatus of claim 1, wherein the multicast packet comprises an Internet Protocol (IP) packet transported using User Datagram Protocol (UDP), wherein the processor is configured to add the multicast destination address of the multicast group to the header of the packet using at least one of a UDP Source Port field, a UDP Destination Port field, or an IP Type field.

5. The apparatus of claim 1, wherein the processor is configured to:
replicate the multicast packet, at the first switch of the multicast tree, to form thereby a replicated multicast packet;
modify the replicated multicast packet at the first switch of the multicast tree, to form thereby a second modified packet, by updating the destination address field of the header to include a unicast destination address of a third switch of the multicast tree and adding the multicast destination address of the multicast group to the header; and
send the second modified packet toward the third switch of the multicast tree.

6. The apparatus of claim 5, wherein the processor is configured to replicate the multicast packet to form thereby the replicated multicast packet based on a group table of the first switch of the multicast tree.

7. The apparatus of claim 1, wherein the processor is configured to:
receive, from a control element, a packet processing rule associated with the multicast group; and
modify the multicast packet to form the modified packet based on the packet processing rule.

8. An apparatus, comprising:
a processor and a memory communicatively connected to the processor, the processor configured to:
receive, at a switch of a multicast tree, a packet comprising a header and a payload, the header comprising a destination address field including a unicast destination address of the switch, the header further comprising a multicast destination address of a multicast group associated with the multicast tree;
generate, at the switch of the multicast tree based on the packet, a set of modified packets associated with respective branches of the multicast tree, the modified packets comprising respective headers and payloads, the respective headers of the modified packets comprising respective destination address fields including respective unicast destination addresses of respective switches associated with the respective branches of the multicast tree, the respective headers of the modified packets each comprising the multicast destination address of the multicast group associated with the multicast tree; and
send the modified packets toward the respective switches associated with the respective branches of the multicast tree.

9. The apparatus of claim 8, wherein the packet comprises an Ethernet frame, wherein, for at least one of the modified packets, the multicast destination address of the multicast group is encoded within the respective Ethernet frame using at least one of an Ethertype field of the Ethernet frame or a virtual local area network (VLAN) Tag field of the Ethernet frame.

10. The apparatus of claim 8, wherein the multicast packet comprises an Internet Protocol (IP) packet transported using User Datagram Protocol (UDP), wherein, for at least one of the modified packets, the multicast destination address of the multicast group is encoded within the respective Ethernet frame using at least one of a UDP Source Port field, a UDP Destination Port field, or an IP Type field.

11. The apparatus of claim 8, wherein, to generate the modified packets, the processor is configured to:
identify the packet as being associated with the multicast group based on the multicast destination address of the multicast group within the header of the packet; and
generate the modified packets based on identification of the packet as being associated with the multicast group.

12. The apparatus of claim 8, wherein the multicast destination address of the multicast group is encoded within the packet, wherein, to generate the modified packets, the processor is configured to:
determine respective encodings of the multicast destination address of the multicast group, for the respective modified packets, based on the encoding of the multicast destination address of the multicast group within the header of the packet.

13. The apparatus of claim 8, wherein the processor is configured to generate the modified packets based on a group table of the switch of the multicast tree.

14. The apparatus of claim 8, wherein the processor is configured to:
receive, from a control element, a packet processing rule associated with the multicast group; and
generate the modified packets based on the packet processing rule.

15. An apparatus, comprising:
a processor and a memory communicatively connected to the processor, the processor configured to:
receive, at a switch of a multicast tree of a multicast group, a packet comprising a header and a payload, the header comprising a destination address field including a unicast destination address identifying the switch of the multicast tree, the header further comprising a multicast destination address of the multicast group;
modify the packet at the switch of the multicast tree, to form thereby a modified packet, by updating the destination address field to include the multicast destination address of the multicast group; and
send the modified packet toward a destination node of the multicast group.

16. The apparatus of claim 15, wherein the packet comprises an Ethernet frame, wherein the multicast destination address of the multicast group is encoded within the Ethernet frame using at least one of an Ethertype field of the Ethernet frame or a virtual local area network (VLAN) Tag field of the Ethernet frame.

17. The apparatus of claim 15, wherein the multicast packet comprises an Internet Protocol (IP) packet transported using User Datagram Protocol (UDP), wherein the multicast destination address of the multicast group is encoded within the Ethernet frame using at least one of a UDP Source Port field, a UDP Destination Port field, or an IP Type field.

18. The apparatus of claim 15, wherein, to modify the packet to form the modified packet, the processor is configured to:
determine the multicast destination address of the multicast group from the header of the packet; and
update the destination address field to replace the unicast destination address with the multicast destination address of the multicast group.

19. The apparatus of claim 15, wherein the multicast destination address of the multicast group is encoded within the packet using at least one field of the header of the packet, wherein, to modify the packet to form the modified packet, the processor is configured to:
update the at least one field of the header to restore at least one value of the at least one field overwritten by the multicast destination address of the multicast group.

20. The apparatus of claim 15, wherein the processor is configured to modify the packet to form the modified packet based on a flow table of the switch of the multicast tree.

21. The apparatus of claim 15, wherein the processor is configured to:
receive, from a control element, a packet processing rule associated with the multicast group; and
modify the packet to form the modified packet based on the packet processing rule.

22. An apparatus, comprising:
a processor and a memory communicatively connected to the processor, the processor configured to:
determine, at a control element, a flow forwarding rule for a switch of a multicast tree of a multicast group having a multicast destination address associated therewith, the flow forwarding rule indicative that, for a packet associated with the multicast group that is received at the switch, the switch is to modify a header of the packet by including a unicast destination address within a destination address field of the packet and by including the multicast destination address of the multicast group within the header; and
send the flow forwarding rule toward the switch of the multicast tree.
